(19) United States
(12) Patent Application Publication
(10) Pub. No.: US 2025/0080860 A1
(43) Pub. Date: Mar. 6, 2025

(54) EXPOSURE CONTROL DEVICE, OPERATION METHOD OF EXPOSURE CONTROL DEVICE, OPERATION PROGRAM OF EXPOSURE CONTROL DEVICE, AND IMAGING APPARATUS

(71) Applicant: FUJIFILM Corporation, Tokyo (JP)

(72) Inventor: Masato FUJII, Saitama (JP)

(73) Assignee: FUJIFILM Corporation, Tokyo (JP)

(21) Appl. No.: 18/820,193

(22) Filed: Aug. 29, 2024

(30) Foreign Application Priority Data
Sep. 4, 2023 (JP) 2023-143058

(51) Int. Cl. H04N 23/743; H04N 23/72; H04N 23/73

(52) U.S. Cl. CPC H04N 23/743; H04N 23/72; H04N 23/73

(57) ABSTRACT

A CPU of a controller of an imaging apparatus includes a setting unit and a driving controller. The driving controller starts an exposure control in a case where an absolute value of a difference between a first target exposure value of a current frame and a second target exposure value of a previous frame is increased above a first threshold value. The setting unit acquires a second threshold value smaller than the first threshold value in accordance with the start of the exposure control. In a case where a magnitude relationship between the absolute value of the difference and the second threshold value satisfies a condition set in advance, the driving controller sets a threshold value to be compared with the absolute value of the difference to a third threshold value greater than the second threshold value and finishes the exposure control.

### CROSS-REFERENCE TO RELATED APPLICATIONS

The present application claims priority under 35 U.S.C. § 119 to Japanese Patent Application No. 2023-143058 filed on Sep. 4, 2023. The above application is hereby expressly incorporated by reference, in its entirety, into the present application.

### BACKGROUND

### 1. Technical Field

The disclosed technology relates to an exposure control device, an operation method of an exposure control device, an operation program of an exposure control device, and an imaging apparatus.

### 2. Description of the Related Art

JP2000-041181A discloses an auto exposure control device that performs an opening and closing control of a lens iris to reduce a value of a difference between a target exposure level and brightness information based on opening and closing position information of the lens iris and on the brightness information. The auto exposure control device according to JP2000-041181A includes a first controller that performs the opening and closing control of the lens iris by compensating a value of a difference between a mechanical hysteresis of the lens iris in a first direction and a mechanical hysteresis of the lens iris in a second direction, by setting different control margin amounts for the target exposure level between a case where the lens iris moves in the first direction from an opening side to a closing side and a case where the lens iris moves in the second direction from the opening side to the closing side.

### SUMMARY

One embodiment according to the disclosed technology provides an exposure control device, an operation method of an exposure control device, an operation program of an exposure control device, and an imaging apparatus that can perform an appropriate exposure control.

An exposure control device according to an aspect of the present disclosure is an exposure control device that performs an exposure control of causing an exposure value in an imaging apparatus to follow a target exposure value, the exposure control device comprising a processor, in which the processor is configured to start the exposure control in a case where an absolute value of a difference between a first target exposure value of a first frame captured by the imaging apparatus and a second target exposure value of a second frame captured earlier than the first frame is increased above a first threshold value, acquire a second threshold value smaller than the first threshold value in accordance with the start of the exposure control, and in a case where a magnitude relationship between the absolute value of the difference and the second threshold value satisfies a condition set in advance, set a threshold value to be compared with the absolute value of the difference to a third threshold value greater than the second threshold value and finish the exposure control.

It is preferable that the processor is configured to set the third threshold value to the same value as the first threshold value.

It is preferable that the processor is configured to set the third threshold value to a value different from the first threshold value in accordance with a condition.

It is preferable that the processor is configured to set the third threshold value to a value smaller than the first threshold value in accordance with the condition.

It is preferable that the condition is a condition based on a detection result of a subject.

It is preferable that the processor is configured to, in a case where the absolute value of the difference becomes less than or equal to the second threshold value, set the threshold value to be compared with the absolute value of the difference to the third threshold value greater than the second threshold value and finish the exposure control.

It is preferable that the processor is configured to store whether the absolute value of the difference is greater than the first threshold value, the second threshold value, or the third threshold value and an exposure control state in which the exposure control is performed is reached, or the absolute value of the difference becomes less than or equal to the first threshold value, the second threshold value, or the third threshold value and an exposure control finish state in which the exposure control is finished is reached, in a storage unit for each frame.

It is preferable that the processor is configured to set the threshold value to be compared with the absolute value of the difference to the first threshold value or to the third threshold value in a case where a state of the second frame is the exposure control finish state, and set the threshold value to be compared with the absolute value of the difference to the second threshold value in a case where the state of the second frame is the exposure control state.

It is preferable that the processor is configured to store the second target exposure value in the storage unit for each frame.

It is preferable that the processor is configured to, in a case where the absolute value of the difference is less than or equal to the first threshold value or the third threshold value and greater than the second threshold value and where a state where a sign of the difference is reversed continues for the number of frames set in advance, set the threshold value to be compared with the absolute value of the difference to the third threshold value greater than the second threshold value and finish the exposure control.

It is preferable that the processor is configured to store the difference in a storage unit.

It is preferable that the processor is configured to store whether the absolute value of the difference is greater than the first threshold value, the second threshold value, or the third threshold value and an exposure control state in which the exposure control is performed is reached, or the absolute value of the difference becomes less than or equal to the first threshold value, the second threshold value, or the third threshold value and an exposure control finish state in which the exposure control is finished is reached, in the storage unit for each frame, and store the difference in the storage unit only in a case where a state of the first frame is the exposure control state.

It is preferable that the processor is configured to store histories of the absolute value of the difference after reaching the exposure control finish state in the storage unit, and subtract the second threshold value from a maximum value in the histories in a case where the maximum value is smaller than the second threshold value.

It is preferable that the processor is configured to, in a case where the histories are stored in the storage unit as many as a number set in advance, perform processing of subtracting the second threshold value from the maximum value.

It is preferable that the processor is configured to not hand over the histories stored in the storage unit in a case where an operation instruction set in advance is received.

It is preferable that the processor is configured to delete the histories from the storage unit in a case where the operation instruction set in advance is received.

An imaging apparatus according to an aspect of the present disclosure comprises the exposure control device, and an imaging element.

An operation method of an exposure control device according to an aspect of the present disclosure is an operation method of an exposure control device that performs an exposure control of causing an exposure value in an imaging apparatus to follow a target exposure value, the operation method comprising starting the exposure control in a case where an absolute value of a difference between a first target exposure value of a first frame captured by the imaging apparatus and a second target exposure value of a second frame captured earlier than the first frame is increased above a first threshold value, acquiring a second threshold value smaller than the first threshold value in accordance with the start of the exposure control, and setting, in a case where a magnitude relationship between the absolute value of the difference and the second threshold value satisfies a condition set in advance, a threshold value to be compared with the absolute value of the difference to a third threshold value greater than the second threshold value and finishing the exposure control.

An operation program of an exposure control device according to an aspect of the present disclosure is an operation program of an exposure control device that performs an exposure control of causing an exposure value in an imaging apparatus to follow a target exposure value, the operation program causing a computer to execute a process comprising starting the exposure control in a case where an absolute value of a difference between a first target exposure value of a first frame captured by the imaging apparatus and a second target exposure value of a second frame captured earlier than the first frame is increased above a first threshold value, acquiring a second threshold value smaller than the first threshold value in accordance with the start of the exposure control, and setting, in a case where a magnitude relationship between the absolute value of the difference and the second threshold value satisfies a condition set in advance, a threshold value to be compared with the absolute value of the difference to a third threshold value greater than the second threshold value and finishing the exposure control.

### BRIEF DESCRIPTION OF THE DRAWINGS

Exemplary embodiments according to the technique of the present disclosure will be described in detail based on the following figures, wherein:

FIG. 1 is a diagram illustrating a configuration of an imaging apparatus;

FIG. 2 is a diagram illustrating a detailed configuration of a controller;

FIG. 3 is a block diagram illustrating a processing unit of a CPU;

FIG. 4 is a diagram illustrating processing of a setting unit in a case where a state of a previous frame is an exposure control finish state;

FIG. 5 is a diagram illustrating processing of the setting unit in a case where the state of the previous frame is an exposure control state;

FIG. 6 is a diagram illustrating processing of a determination unit in a case where a threshold value is set to a first threshold value;

FIG. 7 is a diagram illustrating processing of the determination unit in a case where the threshold value is set to the first threshold value;

FIG. 8 is a diagram illustrating processing of the determination unit in a case where the threshold value is set to a second threshold value;

FIG. 9 is a diagram illustrating processing of the determination unit in a case where the threshold value is set to the second threshold value;

FIG. 10 is a diagram illustrating an example of an imaging scene that requires an exposure control;

FIG. 11 is a graph illustrating trends of a first target exposure value and a second target exposure value;

FIG. 12 is a diagram illustrating processing of a driving controller in a case where the threshold value is set to the first threshold value and where a state of a current frame is the exposure control finish state;

FIG. 13 is a diagram illustrating processing of the driving controller in a case where the threshold value is set to the first threshold value and where the state of the current frame is the exposure control state;

FIG. 14 is a diagram illustrating processing of the driving controller in a case where the threshold value is set to the second threshold value and where the state of the current frame is the exposure control finish state;

FIG. 15 is a diagram illustrating processing of the driving controller in a case where the threshold value is set to the second threshold value and where the state of the current frame is the exposure control state;

FIG. 16 is a flowchart illustrating a processing procedure of the CPU;

FIG. 17 is a flowchart illustrating a processing procedure of the CPU;

FIG. 18 is a graph illustrating trends of the first target exposure value and the second target exposure value in a comparative example;

FIG. 19 is a block diagram illustrating a processing unit of a CPU of a second embodiment;

FIG. 20 is a diagram illustrating processing of a counting unit;

FIG. 21 is a diagram illustrating processing of the counting unit;

FIG. 22 is a diagram illustrating processing of the counting unit;

FIG. 23 is a diagram illustrating processing of the determination unit in a case where the number of reversals is greater than or equal to the set number of frames;

FIG. 24 is a graph illustrating trends of the first target exposure value and the second target exposure value in a case where the number of reversals is greater than or equal to the set number of frames;

FIG. 25 is a diagram illustrating processing of the determination unit in a case where the number of reversals is less than the set number of frames;

FIG. 26 is a diagram illustrating processing of the determination unit in a case where the state of the current frame is the exposure control state;

FIG. 27 is a flowchart illustrating a processing procedure of the CPU of the second embodiment;

FIG. 28 is a flowchart illustrating a processing procedure of the CPU of the second embodiment;

FIG. 29 is a flowchart illustrating a processing procedure of the CPU of the second embodiment;

FIG. 30 is a block diagram illustrating a processing unit of a CPU of a third embodiment;

FIG. 31 is a diagram illustrating history information;

FIG. 32 is a diagram illustrating processing of an RW controller;

FIG. 33 is a diagram illustrating processing of the RW controller in a case where histories of an absolute value of a difference after reaching the exposure control finish state are stored as many as a set number and where a maximum value of the histories is smaller than the second threshold value;

FIG. 34 is a diagram illustrating processing of the RW controller under an instruction to power the imaging apparatus off;

FIG. 35 is a flowchart illustrating a processing procedure of the CPU of the third embodiment;

FIG. 36 is a flowchart illustrating a processing procedure of the CPU of the third embodiment;

FIG. 37 is a flowchart illustrating a processing procedure of the CPU of the third embodiment;

FIG. 38 is a block diagram illustrating a processing unit of a CPU of a fourth embodiment;

FIG. 39 is a diagram illustrating processing of the setting unit in the fourth embodiment; and

FIG. 40 is a diagram illustrating processing of the setting unit in the fourth embodiment.

### DETAILED DESCRIPTION

### First Embodiment

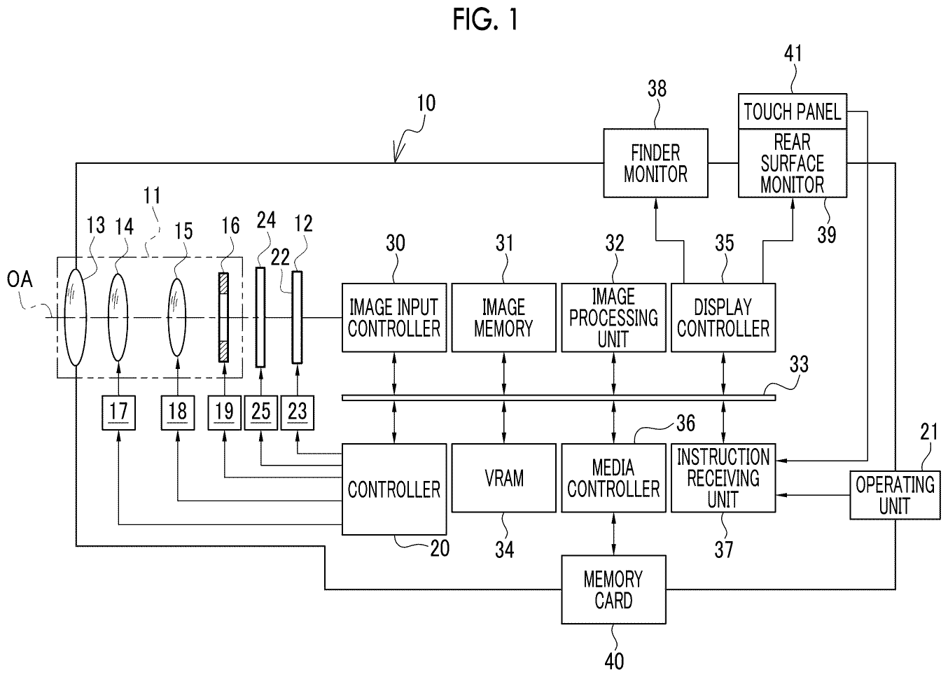

As illustrated in FIG. 1 as an example, an imaging apparatus 10 is, for example, a mirrorless single-lens digital camera and comprises an imaging optical system 11 and an imaging element 12. The imaging optical system 11 includes a plurality of types of lenses for forming an image of subject light on the imaging element 12. Specifically, the imaging optical system 11 includes an objective lens 13, a focus lens 14, and a zoom lens 15. Each of the lenses 13 to 15 is disposed in this order from an object side (subject side) to an image forming side (imaging element 12 side). While illustration is simplified in FIG. 1, each of the lenses 13 to 15 is actually a lens group in which a plurality of lenses are combined. The imaging optical system 11 also includes a stop 16. The stop 16 is disposed closest to the image forming side in the imaging optical system 11. The imaging apparatus 10 may be of a type in which a lens barrel incorporating the imaging optical system 11 or the like is integrated with a body incorporating the imaging element 12 or the like, or a so-called lens-interchangeable type in which the lens barrel is separated from the body.

The focus lens 14 is provided with a focus lens driving mechanism 17. The zoom lens 15 is provided with a zoom lens driving mechanism 18. The stop 16 is provided with a stop opening degree adjusting mechanism 19. The focus lens driving mechanism 17 includes, for example, a focus cam ring that holds the focus lens 14 and that has a circumference on which a cam groove is formed, a focus motor that moves the focus cam ring along an optical axis OA by rotating the focus cam ring about the optical axis OA, and a driver of the focus motor. Similarly, the zoom lens driving mechanism 18 includes a zoom cam ring that holds the zoom lens 15 and that has a circumference on which a cam groove is formed, a zoom motor that moves the zoom cam ring along the optical axis OA by rotating the zoom cam ring about the optical axis OA, a driver of the zoom motor, and the like. The focus cam ring and the zoom cam ring can also be manually rotated by a user from an outside of the lens barrel. That is, in the imaging apparatus 10, focus adjustment and change of a focal length can be performed either electrically by the focus motor and the zoom motor or manually by the user.

The stop 16 is, for example, an iris stop and is configured by combining a plurality of stop leaf blades. In the stop 16, a quantity of light that passes through the stop 16 is adjusted by opening and closing an opening at a center of the stop 16 formed by inner edges of the stop leaf blades, that is, changing an opening degree of the opening (hereinafter, referred to as an opening degree of the stop 16), by moving the stop leaf blades at the same time using a cam mechanism. The stop opening degree adjusting mechanism 19 includes a stop motor that opens and closes the stop leaf blades, a driver of the stop motor, and the like. The stop 16 can also be manually opened and closed by the user. That is, in the imaging apparatus 10, the opening degree of the stop 16 can be adjusted either electrically by the stop motor or manually by the user.

The focus motor, the zoom motor, and the stop motor are, for example, stepping motors. In this case, a position of the focus lens 14 and a position of the zoom lens 15 on the optical axis OA and the opening degree of the stop 16 can be derived from driving amounts of the focus motor, the zoom motor, and the stop motor. The position of the focus lens 14 and the position of the zoom lens 15 may be detected by providing a position sensor, instead of using the driving amounts of the focus motor and the zoom motor.

An electric component such as the motor (the focus motor, the zoom motor, and the stop motor) or the driver of each of the driving mechanisms 17 to 19 is connected to the controller 20. The electric component of each of the driving mechanisms 17 to 19 is driven under control of the controller 20. More specifically, the controller 20 drives the electric component of each of the driving mechanisms 17 to 19 by outputting a driving signal corresponding to an instruction or the like that is input from the user through an operating unit 21. For example, in a case where an instruction to change an angle of view to a telephoto side is input through an angle of view changing switch of the operating unit 21, the controller 20 moves the zoom lens 15 to the telephoto side by outputting a driving signal to the driver of the zoom motor of the zoom lens driving mechanism 18.

The focus motor, the zoom motor, and the stop motor output the driving amounts to the controller 20. The controller 20 derives the position of the focus lens 14 and the position of the zoom lens 15 on the optical axis OA and the opening degree of the stop 16 from the driving amounts.

The imaging element 12 is, for example, a complementary metal-oxide-semiconductor (CMOS) image sensor and includes an imaging surface 22 for capturing the subject light. The imaging surface 22 is formed by a plurality of pixels arranged in two dimensions. The pixels accumulate signal charges corresponding to the subject light and output image signals (voltage signals) corresponding to the signal charges. The imaging element 12 is disposed such that a center of the imaging surface 22 matches the optical axis OA and the imaging surface 22 is orthogonal to the optical axis OA. Here, the terms “match” and “orthogonal” refer to not only completely matching and completely being orthogonal but also matching and being orthogonal in a sense including an error generally allowed in the technical field to which the disclosed technology belongs.

An imaging element driver 23 is connected to the imaging element 12. The imaging element driver 23 is connected to the controller 20. The imaging element driver 23 controls a capturing timing of the subject light for the imaging element 12 by, for example, supplying a vertical scanning signal and a horizontal scanning signal to the imaging element 12 under control of the controller 20. In addition, the imaging element driver 23 sets a gain that is applied to the image signals output from the pixels and that corresponds to an International Organization for Standardization (ISO) sensitivity.

A shutter 24 is provided between the imaging optical system 11 and the imaging element 12. The shutter 24 is, for example, a focal-plane shutter having a front curtain and a rear curtain. A shutter driving mechanism 25 is connected to the shutter 24. The shutter driving mechanism 25 includes an electromagnet that holds the front curtain and the rear curtain and that causes the front curtain and the rear curtain to travel by releasing the hold, a driver of the electromagnet, and the like. The shutter driving mechanism 25 is driven under control of the controller 20 and opens and closes the shutter 24.

The controller 20 is connected to each unit of an image input controller 30, an image memory 31, and an image processing unit 32 through a busline 33. A video random access memory (VRAM) 34, a display controller 35, a media controller 36, an instruction receiving unit 37, and the like are also connected to the busline 33. While illustration is not provided, a strobe driving controller that controls driving of a strobe device, an external communication interface (I/F) that communicates with an external apparatus through a connection terminal such as a universal serial bus (USB) terminal, a wireless communication I/F, or the like is also connected to the busline 33.

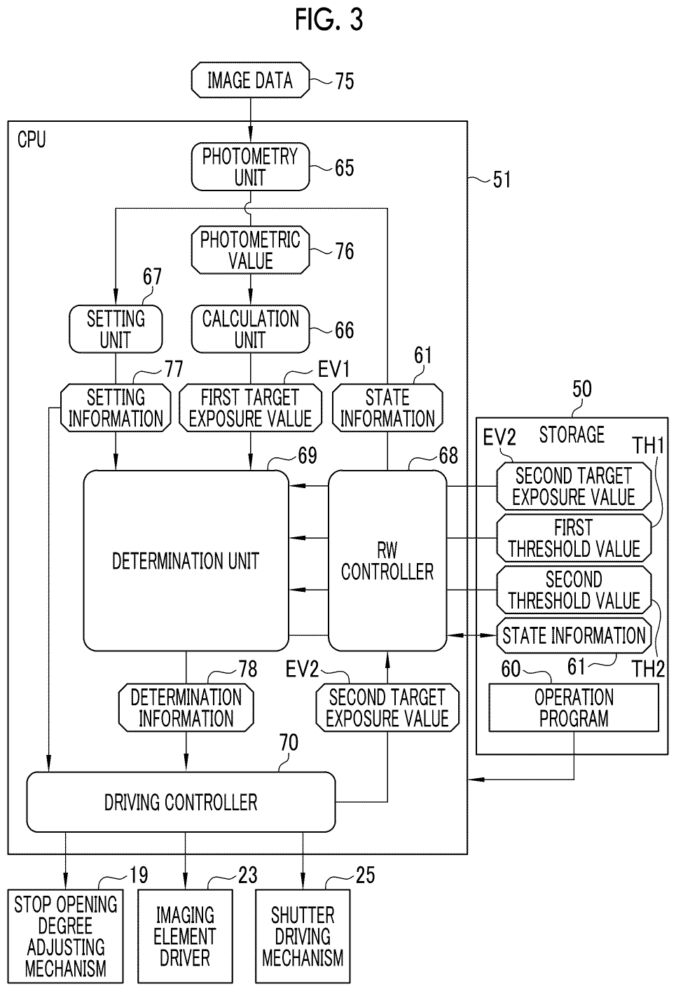

Image data 75 (refer to FIG. 3) obtained by capturing the subject light is input into the image input controller 30 from the imaging element 12. The image input controller 30 outputs the image data 75 to the image memory 31. The image memory 31 is, for example, a synchronous dynamic random access memory (SDRAM) and temporarily stores the image data 75.

The image processing unit 32 reads out unprocessed image data 75 from the image memory 31. The image processing unit 32 performs various types of image processing on the image data 75. The various types of image processing are, for example, offset correction processing, sensitivity correction processing, pixel interpolation processing, white balance correction processing, gamma correction processing, demosaicing processing, brightness signal and color difference signal generation processing, contour highlight processing, and color correction processing. The image processing unit 32 writes the image data 75 after the various types of image processing back to the image memory 31.

The image data 75 to be displayed as a live view image (also referred to as a live preview image) after the various types of image processing is input into the VRAM 34 from the image memory 31. The VRAM 34 has a region for storing the image data 75 of two consecutive frames. The image data 75 stored in the VRAM 34 is sequentially rewritten with new image data 75. The VRAM 34 sequentially outputs the image data 75 that is the newer of the image data 75 of the two consecutive frames to the display controller 35.

The display controller 35 functions as a so-called video encoder that converts the image data 75 from the VRAM 34 into video data and that outputs the video data to any of a finder monitor 38 or a rear surface monitor 39. Accordingly, the live view image can be visible to the user through any of the finder monitor 38 or the rear surface monitor 39. A display frame rate of the live view image is, for example, 60 frames per second (fps).

For example, any of the finder monitor 38 or the rear surface monitor 39 to which the video data is output is determined as follows. That is, a finder is provided with a pupil detection sensor. In a case where the user viewing the finder is detected by the pupil detection sensor, the video data is output to the finder monitor 38. Meanwhile, in a case where the user not viewing the finder is detected by the pupil detection sensor, the video data is output to the rear surface monitor 39.

In a case where an imaging start instruction for a static image or a video is provided by a full press operation of a release button of the operating unit 21, the image processing unit 32 performs compression processing on the image data 75 of the image memory 31. In a case of the static image, the image processing unit 32 performs, for example, compression processing of a Joint Photographic Experts Group (JPEG) format on the image data 75. In a case of the video, the image processing unit 32 performs, for example, compression processing of a Moving Picture Experts Group (MPEG) format on the image data 75. The image processing unit 32 outputs the image data 75 after the compression processing to the media controller 36.

The media controller 36 records the image data 75 after the compression processing from the image processing unit 32 in a memory card 40. The memory card 40 is attachably and detachably mounted in a memory card slot, not illustrated.

In a case where an image playback mode is selected through a mode selector switch of the operating unit 21, the media controller 36 reads out the image data 75 from the memory card 40 and outputs the image data 75 to the image processing unit 32. The image processing unit 32 performs expansion processing on the image data 75 from the memory card 40. The image data 75 after the expansion processing is output to the display controller 35. The display controller 35 converts the image data 75 into video data and outputs the video data to the rear surface monitor 39. Accordingly, a playback image is visible to the user through the rear surface monitor 39.

The instruction receiving unit 37 receives various operation instructions input from the user through the operating unit 21 and through a touch panel 41 provided in an integrated manner with the rear surface monitor 39. The instruction receiving unit 37 outputs the received various operation instructions to the controller 20 through the busline 33.

As described above, the operating unit 21 includes the angle of view changing switch, the release button, and the mode selector switch. The release button is a two-step press button on which a halfway press operation and the full press operation can be performed. An imaging preparation instruction for the static image or the video is provided by the halfway press operation of the release button, and the imaging start instruction for the static image or the video is provided by the full press operation. In addition, the operating unit 21 includes a menu button for displaying various setting menus on the rear surface monitor 39, a cross key used for setting a numerical value, switching between options, and the like, and a confirmation button operated in confirming a setting. A display surface of the rear surface monitor 39 is overlaid with the touch panel 41. The touch panel 41 recognizes various operation instructions from the user by detecting contact with a finger of the user or with a dedicated indicator such as a stylus pen.

Modes that can be switched by the mode selector switch include a static image capturing mode, a video capturing mode, the image playback mode, a setting mode, and the like. The static image capturing mode includes not only a normal imaging mode for capturing one static image but also a continuous imaging mode for continuously capturing static images at a predetermined imaging interval (for example, a frame rate of 5 fps to 10 fps). The continuous imaging mode starts in a case where, for example, a fully pressed state of the release button continues for a predetermined time or longer (for example, 1 second or longer). The continuous imaging mode is finished in a case where the fully pressed state of the release button is released.

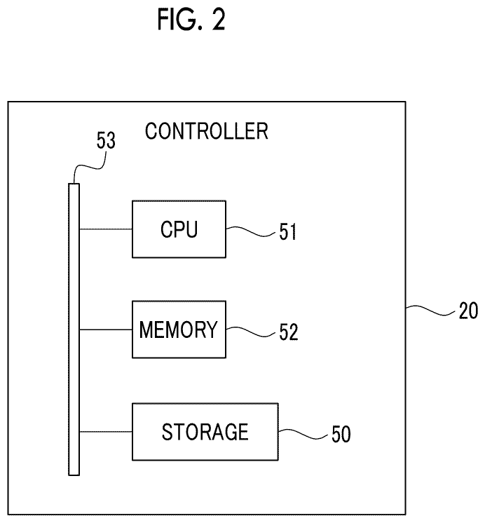

As illustrated in FIG. 2 as an example, the controller 20 comprises a storage 50, a central processing unit (CPU) 51, and a memory 52. The storage 50, the CPU 51, and the memory 52 are connected to each other through a busline 53. The controller 20 is an example of an “exposure control device” and a “computer” according to the disclosed technology.

The storage 50 is, for example, a non-volatile storage device such as an electrically erasable programmable read-only memory (EEPROM). The storage 50 stores various programs and various types of data or the like pertaining to the various programs. The storage 50 is an example of a “storage unit” according to the disclosed technology. Instead of the EEPROM, a ferroelectric random access memory (FeRAM) or a magnetoresistive random access memory (MRAM) may be used as the storage 50.

The memory 52 is a work memory for executing processing via the CPU 51. The CPU 51 loads a program stored in the storage 50 into the memory 52 and executes processing corresponding to the program. Accordingly, the CPU 51 controls each unit of the imaging apparatus 10 in an integrated manner. The CPU 51 is an example of a “processor” according to the disclosed technology. The memory 52 may be incorporated in the CPU 51.

As illustrated in FIG. 3 as an example, the storage 50 stores an operation program 60. The operation program 60 is a program for causing the CPU 51 to perform an exposure control. That is, the operation program 60 is an example of an “operation program of the exposure control device” according to the disclosed technology.

In addition to the operation program 60, the storage 50 also stores a second target exposure value EV2, a first threshold value TH1, a second threshold value TH2, state information 61, and the like. The second target exposure value EV2 is an exposure value as a target for the exposure control in a past frame. Here, the past frame is a previous frame that is earlier than a current frame by one frame. The state information 61 is information indicating whether a state of the previous frame is an exposure control state where the exposure control is performed or an exposure control finish state where the exposure control is finished. The current frame is an example of a “first frame” according to the disclosed technology. In addition, the past frame and the previous frame are examples of a “second frame” according to the disclosed technology.

In a case where the operation program 60 starts, the CPU 51 functions as a photometry unit 65, a calculation unit 66, a setting unit 67, a read write (hereinafter, referred to as read write (RW)) controller 68, a determination unit 69, and a driving controller 70 in cooperation with the memory 52 and the like.

The unprocessed image data 75 of the current frame is input into the photometry unit 65 from the image memory 31. The photometry unit 65 derives a photometric value 76 indicating overall brightness of an image represented by the image data 75 from each pixel value of the image data 75. The photometry unit 65 outputs the photometric value 76 to the calculation unit 66. In a case where a part of a region of the imaging surface 22 of the imaging element 12 is set as an imaging region of the image by an electronic zoom function or by an electronic shake correction function, the photometric value 76 may be derived for only the set imaging region.

The calculation unit 66 calculates the first target exposure value EV1 based on the photometric value 76. The first target exposure value EV1 is an exposure value as a target for the exposure control in the current frame. In other words, the first target exposure value EV1 is an exposure value for providing the image represented by the image data 75 with appropriate brightness. The calculation unit 66 outputs the first target exposure value EV1 to the determination unit 69.

The setting unit 67 sets a threshold value based on the state information 61. More specifically, the setting unit 67 sets a threshold value to be compared in magnitude with an absolute value |ΔEV| of a difference ΔEV (=EV2−EV1) (hereinafter, simply referred to as the absolute value |ΔEV| of the difference) between the first target exposure value EV1 and the second target exposure value EV2, to any of the first threshold value TH1 or the second threshold value TH2. The setting unit 67 outputs setting information 77 of the threshold value to the determination unit 69 and to the driving controller 70.

The RW controller 68 controls storage of various types of data into the storage 50 and reading out of various types of data stored in the storage 50. For example, the RW controller 68 reads out the second target exposure value EV2 from the storage 50 and outputs the read second target exposure value EV2 to the determination unit 69. In addition, the RW controller 68 reads out the first threshold value TH1 and the second threshold value TH2 from the storage 50 and outputs the read first threshold value TH1 and the read second threshold value TH2 to the determination unit 69. Furthermore, the RW controller 68 reads out the state information 61 from the storage 50 and outputs the read state information 61 to the setting unit 67.

The determination unit 69 calculates the difference ΔEV from the first target exposure value EV1 and from the second target exposure value EV2. The determination unit 69 compares a magnitude of the absolute value |ΔEV| of the difference with a magnitude of the first threshold value TH1 or the second threshold value TH2. Whether or not to perform the exposure control of causing the exposure value of the current frame to follow the first target exposure value EV1, that is, whether or not to perform the exposure control, is determined in accordance with a result of the comparison. The determination unit 69 outputs determination information 78 indicating whether or not to perform the exposure control to the driving controller 70.

In addition, the determination unit 69 outputs the state information 61 to the RW controller 68. The RW controller 68 stores the state information 61 in the storage 50. The state information 61 is output to the RW controller 68 from the determination unit 69 for each frame and is updated and stored in the storage 50 for each frame by the RW controller 68. While illustration is not provided, the determination unit 69 also outputs the state information 61 to the driving controller 70.

The driving controller 70 controls driving of the stop opening degree adjusting mechanism 19, the imaging element driver 23, and the shutter driving mechanism 25. The driving controller 70 operates in a case where content of the determination information 78 indicates performing the exposure control. The driving controller 70 adjusts the opening degree of the stop 16, the gain corresponding to the ISO sensitivity of the imaging element 12, and a shutter speed of the shutter 24 in order to set the difference ΔEV between the first target exposure value EV1 and the second target exposure value EV2 to 0.

The driving controller 70 outputs the second target exposure value EV2 to the RW controller 68. The RW controller 68 stores the second target exposure value EV2 in the storage 50. The second target exposure value EV2 is output to the RW controller 68 from the driving controller 70 for each frame and is updated and stored in the storage 50 for each frame by the RW controller 68.

The photometry unit 65, the calculation unit 66, the setting unit 67, the determination unit 69, and the driving controller 70 repeat the processing described above for each frame when the live view image is displayed and/or the video is captured.

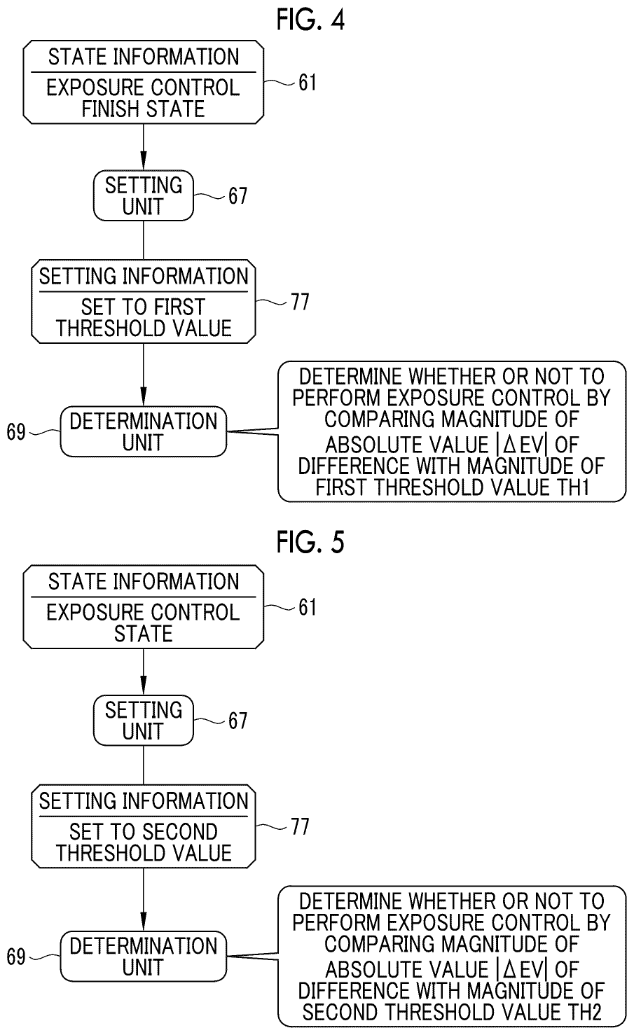

As illustrated in FIG. 4 as an example, in a case where the state of the previous frame indicated by the state information 61 is the exposure control finish state, the setting unit 67 sets the threshold value to the first threshold value TH1. The setting unit 67 outputs the setting information 77 indicating that the threshold value is set to the first threshold value TH1 to the determination unit 69. In this case, the determination unit 69 determines whether or not to perform the exposure control by comparing the magnitude of the absolute value |ΔEV| of the difference with the magnitude of the first threshold value TH1.

Meanwhile, as illustrated in FIG. 5 as an example, in a case where the state of the previous frame indicated by the state information 61 is the exposure control state, the setting unit 67 sets the threshold value to the second threshold value TH2. The setting unit 67 outputs the setting information 77 indicating that the threshold value is set to the second threshold value TH2 to the determination unit 69. In this case, the determination unit 69 determines whether or not to perform the exposure control by comparing the magnitude of the absolute value |ΔEV| of the difference with the magnitude of the second threshold value TH2.

The exposure control is not performed in a case where the absolute value |ΔEV| of the difference is increased above values of the first threshold value TH1 and the second threshold value TH2. Thus, the first threshold value TH1 and the second threshold value TH2 are set as a so-called deadband of the exposure control. Here, the second threshold value TH2 is a value smaller than the first threshold value TH1 (TH2<TH1). For example, the first threshold value TH1 is 20, and the second threshold value TH2 is 5.

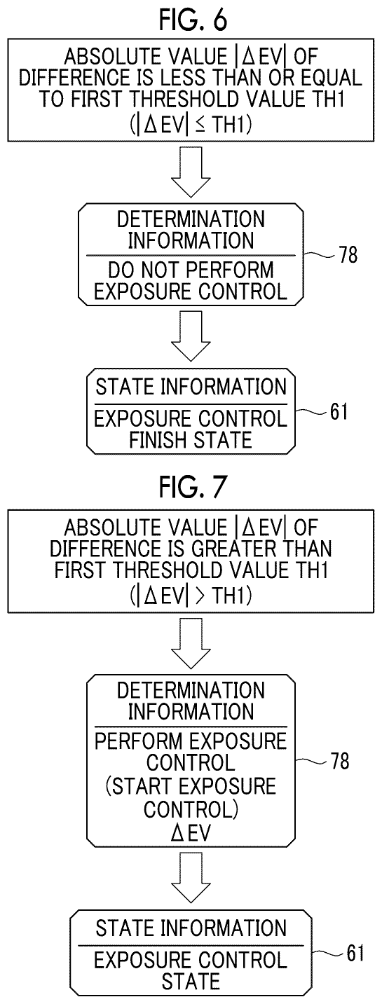

As illustrated in FIG. 6 as an example, in a case where the threshold value is set to the first threshold value TH1 and where the absolute value |ΔEV| of the difference is less than or equal to the first threshold value TH1 (|ΔEV|≤TH1), the determination unit 69 determines not to perform the exposure control and outputs the determination information 78 having content indicating not performing the exposure control to the driving controller 70. In this case, the determination unit 69 outputs the state information 61 having content indicating that a state of the current frame is the exposure control finish state to the RW controller 68.

Meanwhile, as illustrated in FIG. 7 as an example, in a case where the threshold value is set to the first threshold value TH1 and where the absolute value |ΔEV| of the difference is greater than the first threshold value TH1 (|ΔEV|>TH1), the determination unit 69 determines to perform the exposure control and outputs the determination information 78 having content indicating performing the exposure control to the driving controller 70. The determination unit 69 includes the difference ΔEV in the determination information 78. The threshold value is set to the first threshold value TH1 in a case where the state of the previous frame is the exposure control finish state, as illustrated in FIG. 4. Thus, “performing the exposure control” means starting the exposure. In this case, the determination unit 69 outputs the state information 61 having content indicating that the state of the current frame is the exposure control state to the RW controller 68.

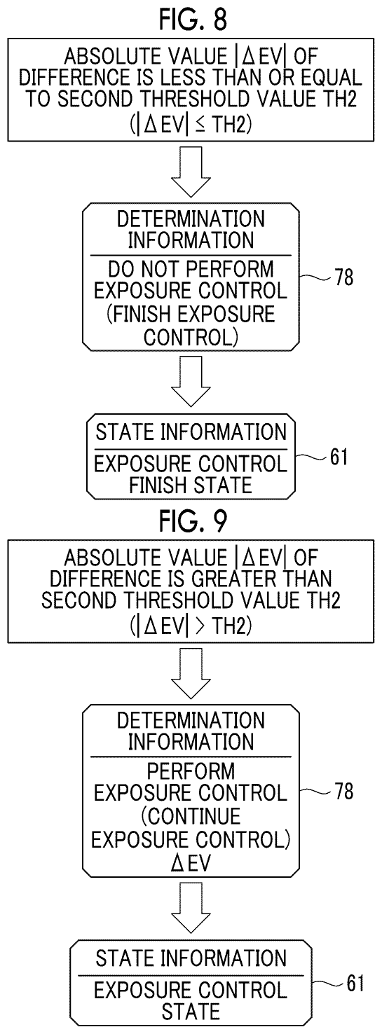

As illustrated in FIG. 8 as an example, in a case where the threshold value is set to the second threshold value TH2 and where the absolute value |ΔEV| of the difference is less than or equal to the second threshold value TH2 (|ΔEV|≤TH2), the determination unit 69 determines not to perform the exposure control and outputs the determination information 78 having content indicating not performing the exposure control to the driving controller 70. The threshold value is set to the second threshold value TH2 in a case where the state of the previous frame is the exposure control state, as illustrated in FIG. 5. Thus, “not performing the exposure control” means finishing the exposure control. In this case, the determination unit 69 outputs the state information 61 having content indicating that the state of the current frame is the exposure control finish state to the RW controller 68. A case where the absolute value |ΔEV| of the difference is less than or equal to the second threshold value TH2 is an example of a “case where a magnitude relationship between an absolute value of a difference and a second threshold value satisfies a condition set in advance” according to the disclosed technology. The “case where the magnitude relationship between the absolute value of the difference and the second threshold value satisfies the condition set in advance” may be a case where the difference |ΔEV| of the difference is decreased below the second threshold value TH2.

In a frame subsequent to the frame illustrated in FIG. 8, the state indicated by the state information 61 is the exposure control finish state. Thus, the setting unit 67 sets the threshold value to the first threshold value TH1, as illustrated in FIG. 4. The first threshold value TH1 is a value greater than the second threshold value TH2. Thus, in a case where the absolute value |ΔEV| of the difference becomes less than or equal to the second threshold value TH2, the setting unit 67 sets a threshold value greater than the second threshold value TH2. That is, in the first embodiment, the first threshold value TH1 is an example of a “third threshold value greater than the second threshold value” according to the disclosed technology.

Meanwhile, as illustrated in FIG. 9 as an example, in a case where the threshold value is set to the second threshold value TH2 and where the absolute value |ΔEV| of the difference is greater than the second threshold value TH2 (|ΔEV|>TH2), the determination unit 69 determines to perform the exposure control and outputs the determination information 78 having content indicating performing the exposure control to the driving controller 70. The determination unit 69 includes the difference ΔEV in the determination information 78. As described above, the threshold value is set to the second threshold value TH2 in a case where the state of the previous frame is the exposure control state, as illustrated in FIG. 5. Thus, “performing the exposure control” means “continuing the exposure control”. In this case, the determination unit 69 outputs the state information 61 having content indicating that the state of the current frame is the exposure control state to the RW controller 68.

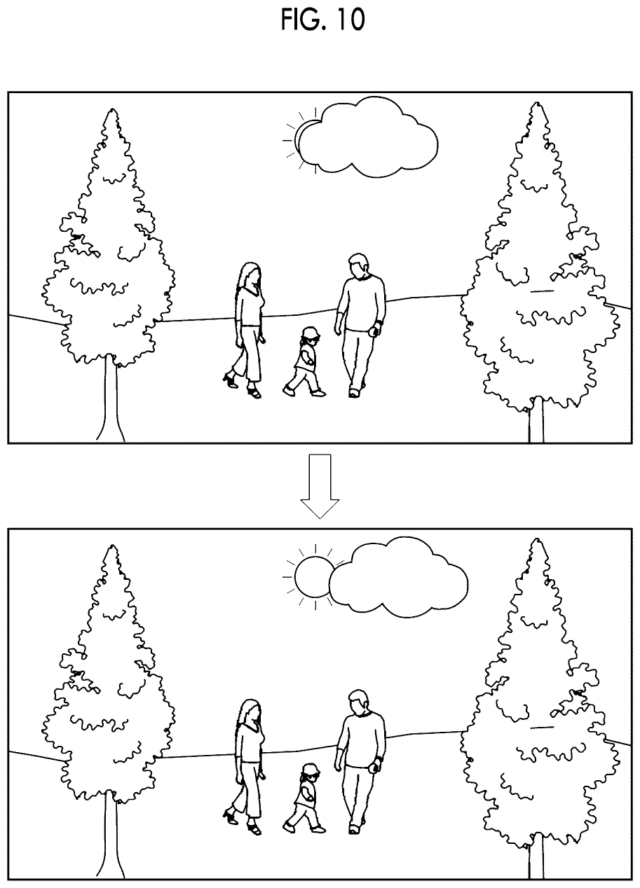

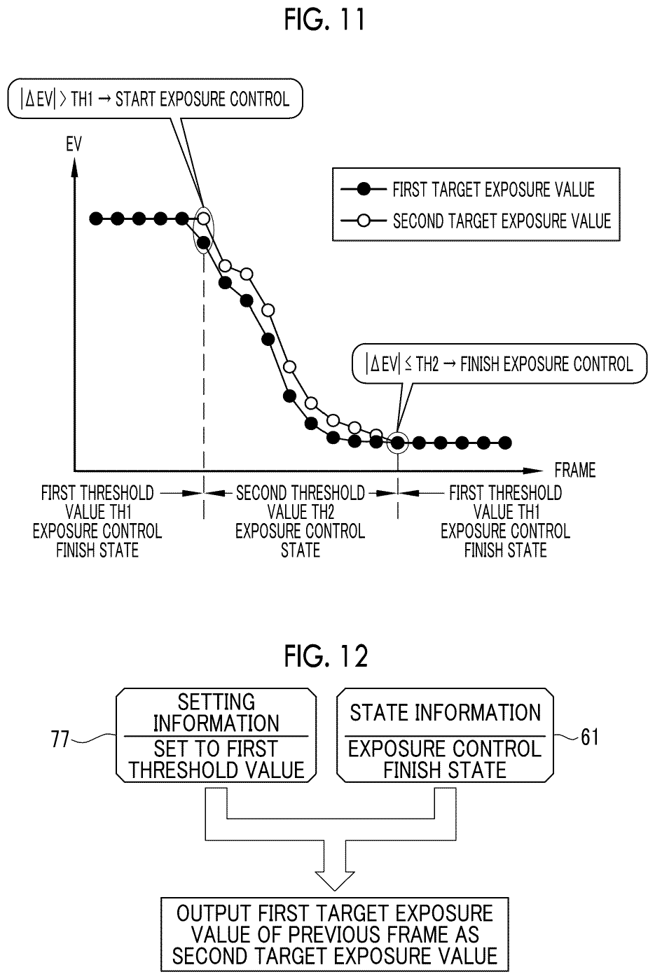

Hereinafter, specific examples will be described. As illustrated in FIG. 10 as an example, in an imaging scene that captures parents and a child playing on a lawn in a park, a case where a cloud moves and the sun appears from a state where the sun is blocked by the cloud is considered. In this case, the photometric value 76 indicating the brightness of the image is gradually increased. Thus, as illustrated by black circles of the graph in FIG. 11 as an example, the value of the first target exposure value EV1 is gradually decreased so that the image represented by the image data 75 has appropriate brightness.

In a case where the exposure control finish state is reached by appropriately performing the exposure control in a state where the sun is blocked by the cloud as illustrated above an arrow in FIG. 10, the threshold value is set to the first threshold value TH1. In a case where the cloud moves and the sun gradually appears, the first target exposure value EV1 starts to decrease. Accordingly, the difference ΔEV between the first target exposure value EV1 and the second target exposure value EV2 starts to increase. In a case where the difference ΔEV is increased, the absolute value |ΔEV| of the difference is also increased, and the absolute value |ΔEV| of the difference is eventually increased above the first threshold value TH1.

In a case where the absolute value |ΔEV| of the difference is increased above the first threshold value TH1, the determination unit 69 determines to perform the exposure control, and the driving controller 70 starts the exposure control. Accordingly, the exposure control state is reached, and the setting unit 67 sets the threshold value to the second threshold value TH2.

In a case where a state where the sun has appeared as illustrated below the arrow in FIG. 10 is reached, the photometric value 76 indicating the brightness of the image is almost constant, and the first target exposure value EV1 is almost constant at a relatively low value. Accordingly, the difference ΔEV is decreased, the absolute value |ΔEV| of the difference is also decreased, and the absolute value |ΔEV| of the difference eventually becomes less than or equal to the second threshold value TH2.

In a case where the absolute value |ΔEV| of the difference becomes less than or equal to the second threshold value TH2, the determination unit 69 determines not to perform the exposure control, and the driving controller 70 finishes the exposure control. Accordingly, the exposure control finish state is reached, and the setting unit 67 sets the threshold value to the first threshold value TH1 again.

As illustrated in FIG. 12 as an example, in a case where the setting information 77 from the setting unit 67 has content indicating that the first threshold value TH1 is set and where the state of the current frame indicated by the state information 61 from the determination unit 69 is the exposure control finish state, the driving controller 70 outputs the first target exposure value EV1 calculated by the calculation unit 66 in the previous frame to the RW controller 68 as the second target exposure value EV2.

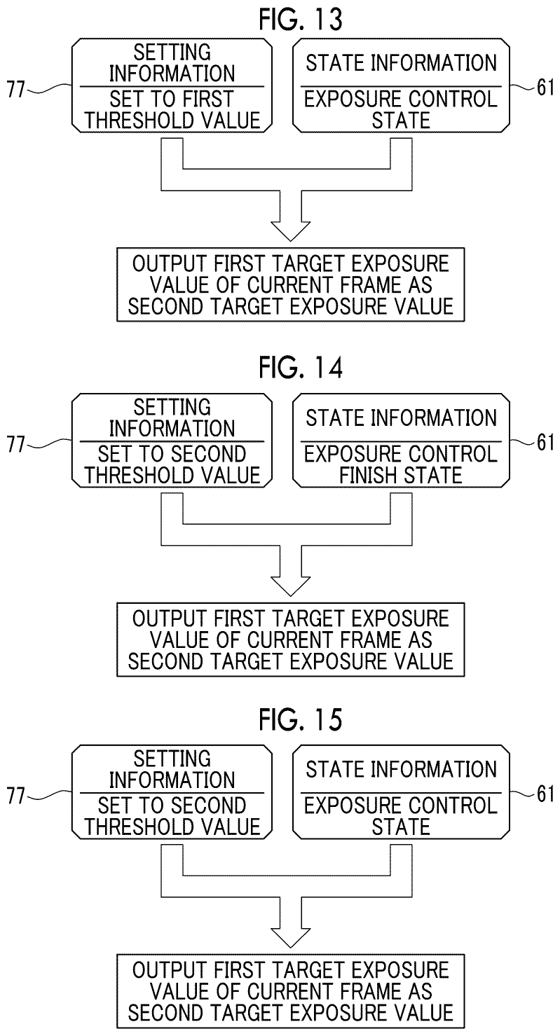

As illustrated in FIG. 13 as an example, in a case where the setting information 77 from the setting unit 67 has content indicating that the first threshold value TH1 is set and where the state of the current frame indicated by the state information 61 from the determination unit 69 is the exposure control state, the driving controller 70 outputs the first target exposure value EV1 calculated by the calculation unit 66 in the current frame to the RW controller 68 as the second target exposure value EV2.

As illustrated in FIG. 14 as an example, in a case where the setting information 77 from the setting unit 67 has content indicating that the second threshold value TH2 is set and where the state of the current frame indicated by the state information 61 from the determination unit 69 is the exposure control finish state, the driving controller 70, as in the case in FIG. 13, outputs the first target exposure value EV1 calculated by the calculation unit 66 in the current frame to the RW controller 68 as the second target exposure value EV2.

As illustrated in FIG. 15 as an example, in a case where the setting information 77 from the setting unit 67 has content indicating that the second threshold value TH2 is set and where the state of the current frame indicated by the state information 61 from the determination unit 69 is the exposure control state, the driving controller 70, as in the cases in FIGS. 13 and 14, outputs the first target exposure value EV1 calculated by the calculation unit 66 in the current frame to the RW controller 68 as the second target exposure value EV2.

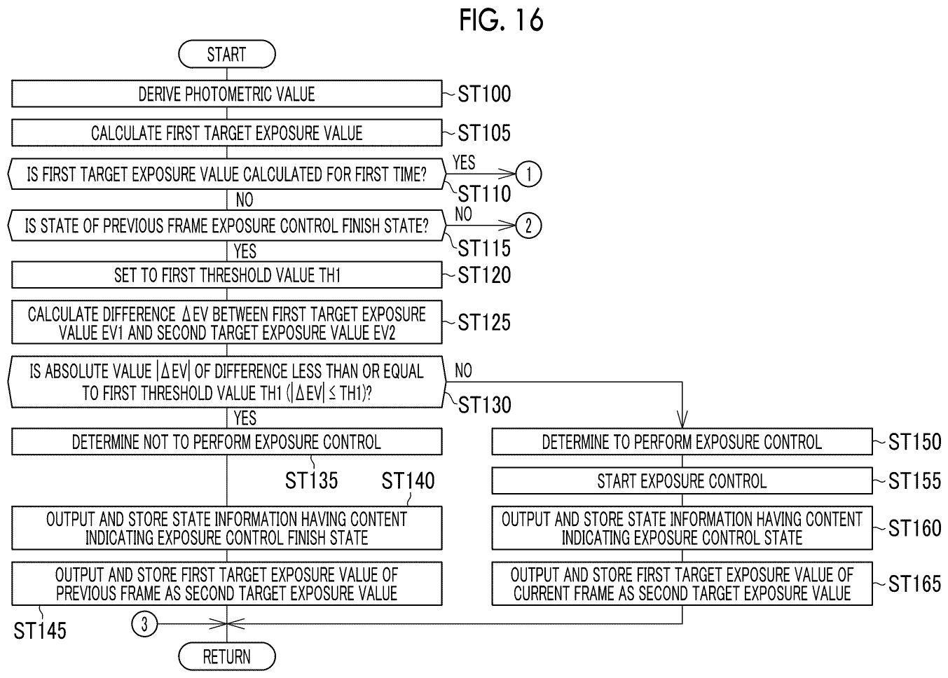

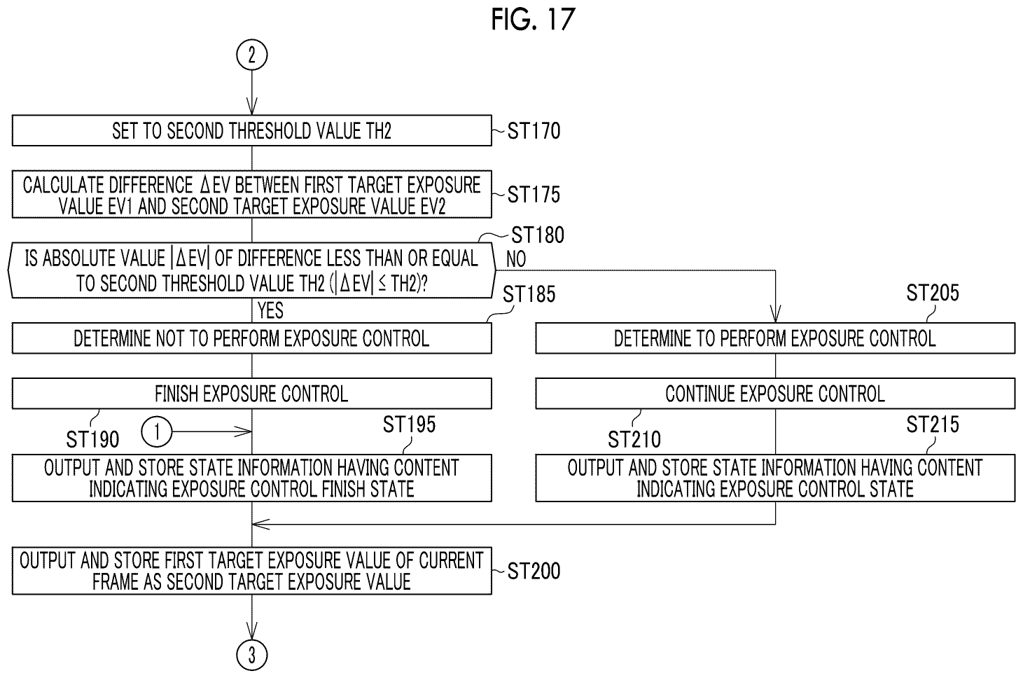

Next, an action of the above configuration will be described with reference to the flowcharts illustrated in FIGS. 16 and 17 as an example. As illustrated in FIG. 3, the CPU 51 of the controller 20 functions as the photometry unit 65, the calculation unit 66, the setting unit 67, the RW controller 68, the determination unit 69, and the driving controller 70 by starting the operation program 60.

The unprocessed image data 75 of the current frame is input into the photometry unit 65 from the image memory 31. As illustrated in FIG. 16, the photometric value 76 is derived in the photometry unit 65 (step ST100). The photometric value 76 is output to the calculation unit 66 from the photometry unit 65.

In the calculation unit 66, the first target exposure value EV1 is calculated based on the photometric value 76 (step ST105). The first target exposure value EV1 is output to the determination unit 69 from the calculation unit 66.

In a case where the first target exposure value EV1 is calculated for the first time by the calculation unit 66 (YES in step ST110), processing transitions to step ST195 in FIG. 17. Meanwhile, in a case where the first target exposure value EV1 is not calculated for the first time by the calculation unit 66 (NO in step ST110), the state information 61 is read out from the storage 50, and the read state information 61 is output to the setting unit 67, under control of the RW controller 68. In addition, under control of the RW controller 68, the second target exposure value EV2, the first threshold value TH1, and the second threshold value TH2 are read out from the storage 50, and the read second target exposure value EV2, the read first threshold value TH1, and the read second threshold value TH2 are output to the determination unit 69.

In the setting unit 67, the threshold value is set based on the state information 61. That is, in a case where the state of the previous frame indicated by the state information 61 is the exposure control finish state (YES in step ST115), the threshold value is set to the first threshold value TH1 as illustrated in FIG. 4 (step ST120).

In the determination unit 69, the difference ΔEV between the first target exposure value EV1 and the second target exposure value EV2 is calculated (step ST125). The magnitude of the absolute value |ΔEV| of the difference is compared with the magnitude of the first threshold value TH1 (step ST130).

In a case where the absolute value |ΔEV| of the difference is less than or equal to the first threshold value TH1 (|ΔEV|≤TH1, YES in step ST130), the determination unit 69 determines not to perform the exposure control as illustrated in FIG. 6 (step ST135). The determination information 78 having content indicating not performing the exposure control is output to the driving controller 70 from the determination unit 69. In this case, the state information 61 having content indicating the exposure control finish state is output to the RW controller 68 from the determination unit 69, and the state information 61 is stored in the storage 50 under control of the RW controller 68 (step ST140). Furthermore, as illustrated in FIG. 12, the first target exposure value EV1 of the previous frame is output to the RW controller 68 from the driving controller 70 as the second target exposure value EV2, and the second target exposure value EV2 is stored in the storage 50 under control of the RW controller 68 (step ST145). Then, the processing transitions to the subsequent frame.

Meanwhile, in a case where the absolute value |ΔEV| of the difference is greater than the first threshold value TH1 (|ΔEV|>TH1, NO in step ST130), the determination unit 69 determines to perform the exposure control as illustrated in FIG. 7 (step ST150). The determination information 78 that has content indicating performing the exposure control and that includes the difference ΔEV is output to the driving controller 70 from the determination unit 69. Accordingly, the exposure control starts under control of the driving controller 70 (step ST155). In this case, the state information 61 having content indicating the exposure control state is output to the RW controller 68 from the determination unit 69, and the state information 61 is stored in the storage 50 under control of the RW controller 68 (step ST160). Furthermore, as illustrated in FIG. 13, the first target exposure value EV1 of the current frame is output to the RW controller 68 from the driving controller 70 as the second target exposure value EV2, and the second target exposure value EV2 is stored in the storage 50 under control of the RW controller 68 (step ST165). Then, the processing transitions to the subsequent frame.

In a case where the state of the previous frame indicated by the state information 61 is the exposure control state (NO in step ST115), the processing transitions to step ST170 in FIG. 17. That is, as illustrated in FIG. 5, the threshold value is set to the second threshold value TH2.

In the determination unit 69, the difference ΔEV between the first target exposure value EV1 and the second target exposure value EV2 is calculated as in step ST125 (step ST175). The magnitude of the absolute value |ΔEV| of the difference is compared with the magnitude of the second threshold value TH2 (step ST180).

In a case where the absolute value |ΔEV| of the difference is less than or equal to the second threshold value TH2 (|ΔEV|≤TH2, YES in step ST180), the determination unit 69 determines not to perform the exposure control as illustrated in FIG. 8 (step ST185). The determination information 78 having content indicating not performing the exposure control is output to the driving controller 70 from the determination unit 69. Accordingly, the exposure control by the driving controller 70 is finished (step ST190). In this case, the state information 61 having content indicating the exposure control finish state is output to the RW controller 68 from the determination unit 69, and the state information 61 is stored in the storage 50 under control of the RW controller 68 (step ST195). Furthermore, as illustrated in FIG. 14, the first target exposure value EV1 of the current frame is output to the RW controller 68 from the driving controller 70 as the second target exposure value EV2, and the second target exposure value EV2 is stored in the storage 50 under control of the RW controller 68 (step ST200). Then, the processing transitions to the subsequent frame.

The same applies to a case where the first target exposure value EV1 is calculated for the first time by the calculation unit 66 (YES in step ST110). The state information 61 having content indicating the exposure control finish state is output to the RW controller 68 from the determination unit 69, and the state information 61 is stored in the storage 50 under control of the RW controller 68 (step ST195). Furthermore, the first target exposure value EV1 of the current frame is output to the RW controller 68 from the driving controller 70 as the second target exposure value EV2, and the second target exposure value EV2 is stored in the storage 50 under control of the RW controller 68 (step ST200).

Meanwhile, in a case where the absolute value |ΔEV| of the difference is greater than the second threshold value TH2 (|ΔEV|>TH2, NO in step ST180), the determination unit 69 determines to perform the exposure control as illustrated in FIG. 9 (step ST205). The determination information 78 that has content indicating performing the exposure control and that includes the difference ΔEV is output to the driving controller 70 from the determination unit 69. Accordingly, the exposure control continues under control of the driving controller 70 (step ST210). In this case, the state information 61 having content indicating the exposure control state is output to the RW controller 68 from the determination unit 69, and the state information 61 is stored in the storage 50 under control of the RW controller 68 (step ST215). Furthermore, as illustrated in FIG. 15, the first target exposure value EV1 of the current frame is output to the RW controller 68 from the driving controller 70 as the second target exposure value EV2, and the second target exposure value EV2 is stored in the storage 50 under control of the RW controller 68 (step ST200). Then, the processing transitions to the subsequent frame.

As described above, the CPU 51 of the controller 20 of the imaging apparatus 10 comprises the setting unit 67 and the driving controller 70. The driving controller 70 starts the exposure control in a case where the absolute value |ΔEV| of the difference between the first target exposure value EV1 of the current frame and the second target exposure value EV2 of the previous frame is increased above the first threshold value TH1. The setting unit 67 acquires the second threshold value TH2 smaller than the first threshold value TH1 in accordance with the start of the exposure control. In a case where the magnitude relationship between the absolute value |ΔEV| of the difference and the second threshold value TH2 satisfies the condition set in advance, the driving controller 70 sets the threshold value to be compared with the absolute value |ΔEV| of the difference to the third threshold value, here, the first threshold value TH1, greater than the second threshold value TH2 and finishes the exposure control.

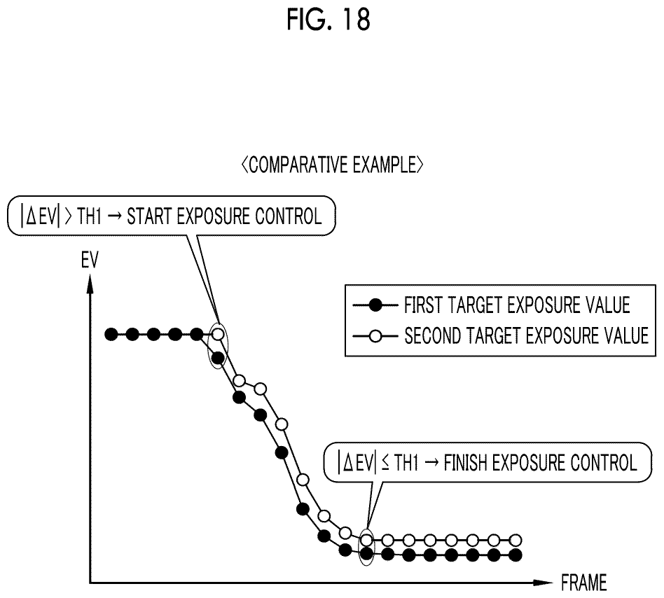

A comparative example in FIG. 18 illustrates a case where the exposure control is performed without changing the threshold value which is the first threshold value TH1. In this case, since the first threshold value TH1 is relatively large and the deadband of the exposure control is wide, there is a concern that the exposure control finish state is reached while a significant increase in the difference ΔEV between the first target exposure value EV1 and the second target exposure value EV2 is maintained (a maximum increase corresponding to the first threshold value TH1 is maintained) and that a state where an image having appropriate brightness cannot be provided is reached.

Meanwhile, in the imaging apparatus 10 of the present disclosure, the threshold value is changed to the second threshold value TH2 smaller than the first threshold value TH1 in accordance with the start of the exposure control. Thus, the concern that the exposure control finish state is reached while a significant increase in the difference ΔEV between the first target exposure value EV1 and the second target exposure value EV2 is maintained and that a state where an image having appropriate brightness cannot be provided is reached can be reduced. Accordingly, appropriate exposure control can be performed.

The setting unit 67 sets the first threshold value TH1 as the third threshold value. Thus, setting of the threshold value can be simplified.

In a case where the absolute value |ΔEV| of the difference becomes less than or equal to the second threshold value TH2, the driving controller 70 finishes the exposure control. Thus, the difference ΔEV between the first target exposure value EV1 and the second target exposure value EV2 in the exposure control finish state always becomes less than or equal to the second threshold value TH2. By setting the second threshold value TH2 to an appropriate value, an image having appropriate brightness can be provided.

The determination unit 69 outputs the state information 61 indicating whether the absolute value |ΔEV| of the difference is greater than the first threshold value TH1 or the second threshold value TH2 and the exposure control state where the exposure control is performed is reached, or the absolute value |ΔEV| of the difference becomes less than or equal to the first threshold value TH1 or the second threshold value TH2 and the exposure control finish state where the exposure control is finished is reached, to the RW controller 68. The RW controller 68 stores the state information 61 in the storage 50 for each frame. Thus, which of the exposure control state and the exposure control finish state is the state of the previous frame can be reliably perceived. The setting of the threshold value by the setting unit 67 based on the state information 61 can be performed without error.

In a case where the state of the previous frame is the exposure control finish state, the setting unit 67 sets the threshold value to the first threshold value TH1. Meanwhile, in a case where the state of the previous frame is the exposure control state, the setting unit 67 sets the threshold value to the second threshold value TH2. In the exposure control finish state, the deadband of the exposure control is widened by setting the threshold value to the first threshold value TH1. Accordingly, hunting in which the exposure control is frequently performed in response to each slight change in the difference ΔEV between the first target exposure value EV1 and the second target exposure value EV2 can be avoided. Meanwhile, in the exposure control state, the deadband of the exposure control is narrowed by setting the threshold value to the second threshold value TH2. Accordingly, the concern that the exposure control finish state is reached while a significant increase in the difference ΔEV between the first target exposure value EV1 and the second target exposure value EV2 is maintained can be reduced.

The driving controller 70 outputs the second target exposure value EV2 to the RW controller 68. The RW controller 68 stores the second target exposure value EV2 in the storage 50 for each frame. Thus, the difference ΔEV between the first target exposure value EV1 and the second target exposure value EV2 can be reliably calculated.

### Second Embodiment

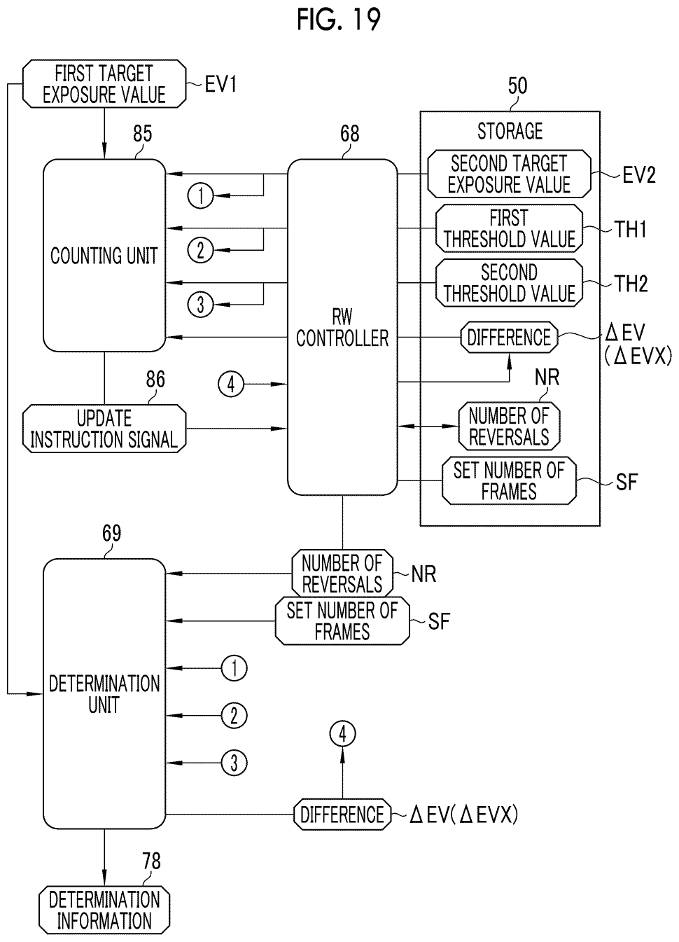

As illustrated in FIG. 19 as an example, in a second embodiment, the CPU 51 functions as a counting unit 85 in addition to each of the processing units 65 to 70 (only the RW controller 68 and the determination unit 69 are illustrated) of the first embodiment. The first target exposure value EV1 is input into the counting unit 85 from the calculation unit 66.

The RW controller 68 reads out the second target exposure value EV2, the first threshold value TH1, and the second threshold value TH2 from the storage 50 and outputs the read second target exposure value EV2, the read first threshold value TH1, and the read second threshold value TH2 to the counting unit 85 and to the determination unit 69. In addition, the RW controller 68 reads out the difference ΔEV between the first target exposure value EV1 and the second target exposure value EV2 from the storage 50 and outputs the read difference ΔEV to the counting unit 85. The difference ΔEV is calculated by the determination unit 69 in the previous frame. Hereinafter, the difference ΔEV will be referred to as a difference ΔEVX in order to distinguish the difference ΔEV from the difference ΔEV of the current frame.

The storage 50 also stores the number of reversals NR and the set number of frames SF. The number of reversals NR is the number of times a sign of the difference ΔEV is consecutively reversed. The set number of frames SF is a threshold value to be compared in magnitude with the number of reversals NR and is, for example, 5 to 10. The set number of frames SF is an example of the “number of frames set in advance” according to the disclosed technology. The RW controller 68 reads out the number of reversals NR and the set number of frames SF from the storage 50 and outputs the read number of reversals NR and the read set number of frames SF to the determination unit 69.

The counting unit 85 calculates the difference ΔEV between the first target exposure value EV1 and the second target exposure value EV2. The counting unit 85 generates an update instruction signal 86 of the number of reversals NR based on the difference ΔEV of the current frame, the difference ΔEVX of the previous frame, the first threshold value TH1, and the second threshold value TH2. The counting unit 85 outputs the update instruction signal 86 to the RW controller 68. The RW controller 68 updates the number of reversals NR in accordance with the update instruction signal 86.

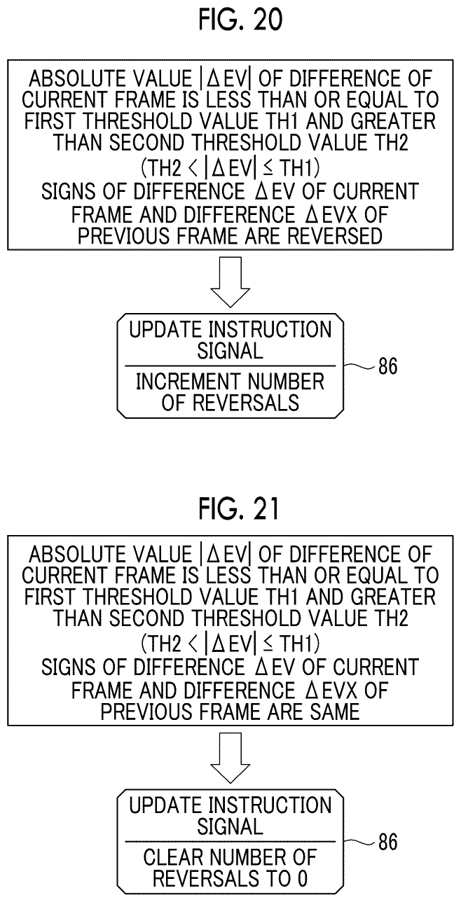

As illustrated in FIG. 20 as an example, in a case where the absolute value |ΔEV| of the difference of the current frame is less than or equal to the first threshold value TH1 and greater than the second threshold value TH2 (TH2<|ΔEV|≤TH1) and where signs of the difference ΔEV of the current frame and the difference ΔEVX of the previous frame are reversed, the counting unit 85 outputs the update instruction signal 86 for incrementing the number of reversals NR to the RW controller 68. The RW controller 68 increments the number of reversals NR in accordance with the update instruction signal 86.

Meanwhile, as illustrated in FIG. 21 as an example, in a case where the absolute value |ΔEV| of the difference of the current frame is less than or equal to the first threshold value TH1 and greater than the second threshold value TH2 and where the signs of the difference ΔEV of the current frame and the difference ΔEVX of the previous frame are the same, the counting unit 85 outputs the update instruction signal 86 for clearing the number of reversals NR to 0 to the RW controller 68. The RW controller 68 clears the number of reversals NR to 0 in accordance with the update instruction signal 86. Clearing the number of reversals NR to 0 means setting the number of reversals NR to 0.

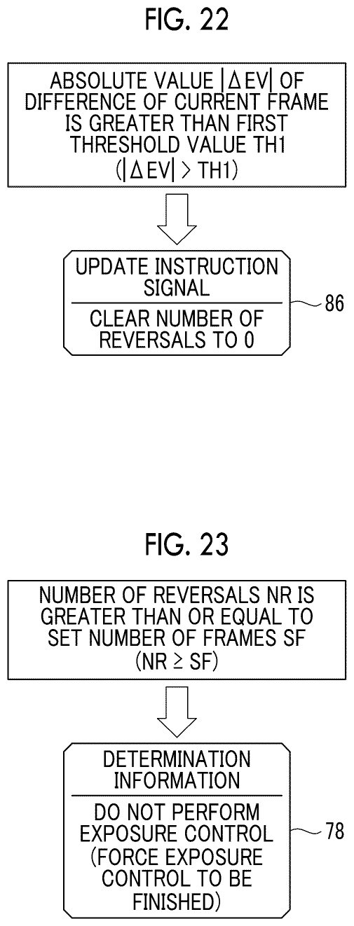

In addition, as illustrated in FIG. 22 as an example, in a case where the absolute value |ΔEV| of the difference of the current frame is greater than the first threshold value TH1 (|ΔEV|>TH1), the counting unit 85 also outputs the update instruction signal 86 for clearing the number of reversals NR to 0 to the RW controller 68. The RW controller 68 clears the number of reversals NR to 0 in accordance with the update instruction signal 86.

As illustrated in FIG. 23 as an example, in a case where the number of reversals NR is greater than or equal to the set number of frames SF (NR>SF), the determination unit 69 determines not to perform the exposure control and outputs the determination information 78 having content indicating not performing the exposure control to the driving controller 70.

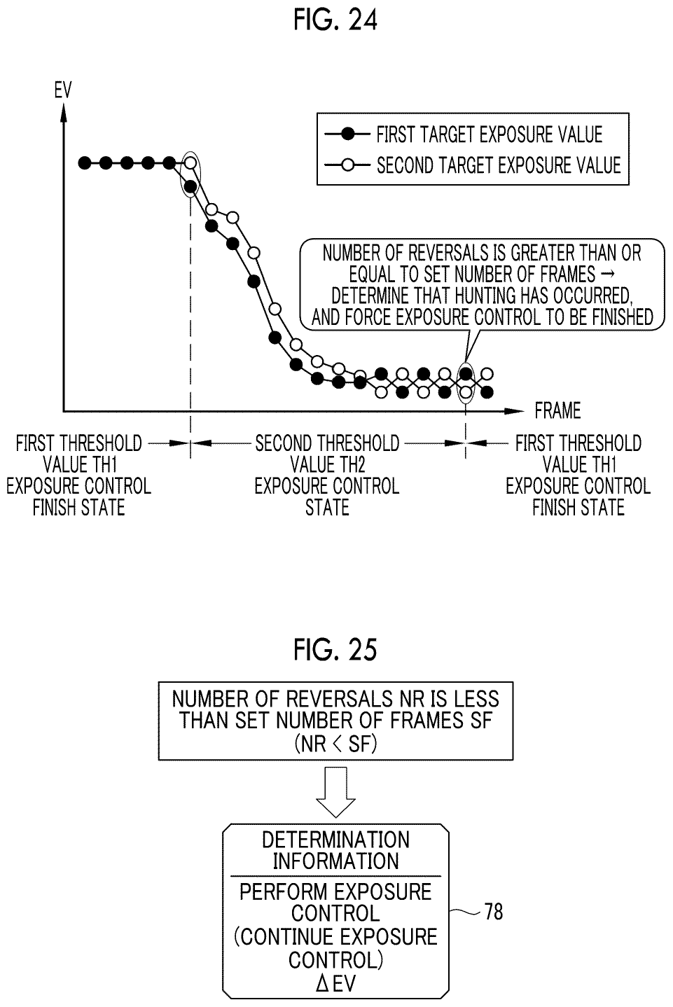

As illustrated in FIG. 24 as an example, a state where the number of reversals NR is greater than or equal to the set number of frames SF is a state where the first target exposure value EV1 and the second target exposure value EV2 continue changing slightly as approaching the end of the exposure control state and where the hunting has occurred because the exposure control is frequently performed in response to each change. In this case, the determination unit 69 determines that a further exposure control is unnecessary because of the occurrence of the hunting and determines not to perform the exposure control. Thus, “do not perform exposure control” illustrated in FIG. 23 means forcing the exposure control to be finished.

Meanwhile, as illustrated in FIG. 25 as an example, in a case where the number of reversals NR is less than the set number of frames SF (NR<SF), the determination unit 69 determines to perform the exposure control and outputs the determination information 78 having content indicating performing the exposure control to the driving controller 70. The determination unit 69 includes the difference ΔEV in the determination information 78. In this case, “performing the exposure control” means continuing the exposure control.

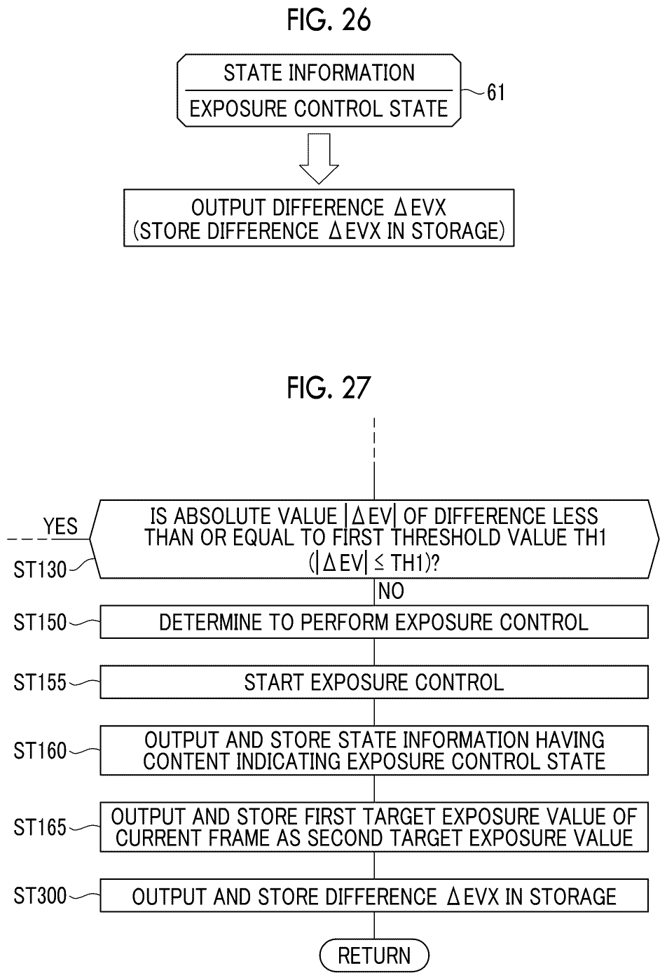

As illustrated in FIG. 26 as an example, the determination unit 69 outputs the difference ΔEVX to the RW controller 68 only in a case where the state of the current frame indicated by the state information 61 is the exposure control state. The RW controller 68 stores the difference ΔEVX in the storage 50.

An action of the second embodiment will be described with reference to the flowcharts illustrated in FIGS. 27 to 29 as an example. Description of the same processing as the first embodiment will be omitted as much as possible, and processing specific to the second embodiment will be mainly described.

First, as illustrated in FIG. 27, in a case where the absolute value |ΔEV| of the difference is greater than the first threshold value TH1 (NO in step ST130), the exposure control starts under control of the driving controller 70 (step ST155), and the state information 61 having content indicating the exposure control state is output to the RW controller 68 from the determination unit 69 (step ST160), the difference ΔEVX is output to the RW controller 68 from the determination unit 69 as illustrated in FIG. 26, and the difference ΔEVX is stored in the storage 50 under control of the RW controller 68 (step ST300).

Under control of the RW controller 68, the second target exposure value EV2, the first threshold value TH1, and the second threshold value TH2 are read out from the storage 50, and the read second target exposure value EV2, the read first threshold value TH1, and the read second threshold value TH2 are output to the counting unit 85 and the determination unit 69. In addition, under control of the RW controller 68, the difference ΔEVX of the previous frame is read out from the storage 50, and the read difference ΔEVX is output to the counting unit 85.

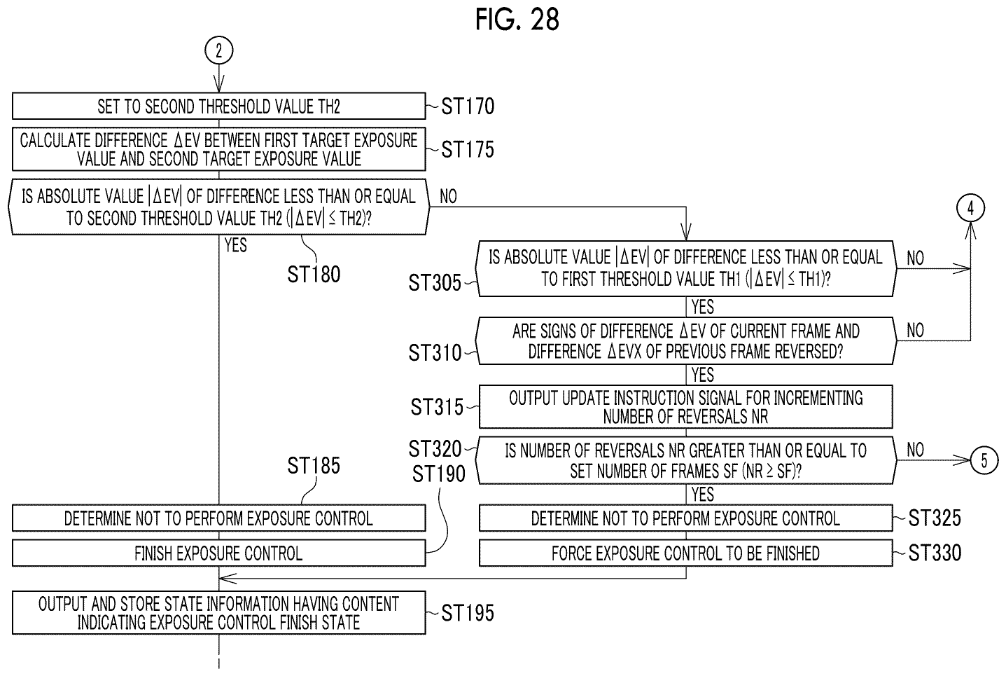

As illustrated in FIG. 28, in a case where the setting unit 67 sets the threshold value to the second threshold value TH2 (step ST170) and where the absolute value |ΔEV| of the difference is greater than the second threshold value TH2 (NO in step ST180), the magnitude of the absolute value |ΔEV| of the difference is compared with the magnitude of the first threshold value TH1 in the counting unit 85 (step ST305).

In a case where the absolute value |ΔEV| of the difference is less than or equal to the first threshold value TH1 (|ΔEV|≤TH1, YES in step ST305), whether or not the signs of the difference ΔEV of the current frame and the difference ΔEVX of the previous frame are reversed is determined in the counting unit 85 (step ST310).

In a case where the signs of the difference ΔEV of the current frame and the difference ΔEVX of the previous frame are reversed (YES in step ST310), the update instruction signal 86 for incrementing the number of reversals NR is output to the RW controller 68 from the counting unit 85 as illustrated in FIG. 20 (step ST315). The RW controller 68 increments the number of reversals NR in the storage 50 in accordance with the update instruction signal 86.

Under control of the RW controller 68, the number of reversals NR and the set number of frames SF are read out from the storage 50, and the read number of reversals NR and the read set number of frames SF are output to the determination unit 69.

In the determination unit 69, a magnitude of the number of reversals NR is compared with a magnitude of the set number of frames SF (step ST320). In a case where the number of reversals NR is greater than or equal to the set number of frames SF (YES in step ST320), the determination unit 69 determines not to perform the exposure control as illustrated in FIG. 23 (step ST325). The determination information 78 having content indicating not performing the exposure control is output to the driving controller 70 from the determination unit 69. Accordingly, the exposure control by the driving controller 70 is forced to be finished (step ST330).

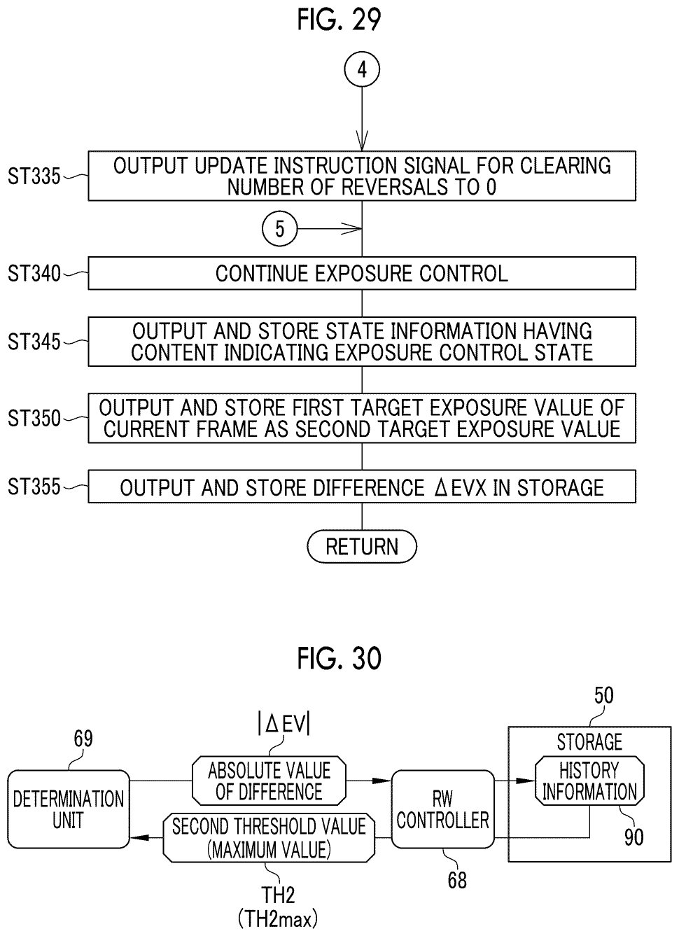

In a case where the absolute value |ΔEV| of the difference is greater than the first threshold value TH1 (|ΔEV|>TH1, NO in step ST305), and in a case where the signs of the difference ΔEV of the current frame and the difference ΔEVX of the previous frame are the same (NO in step ST310), the processing transitions to step ST335 in FIG. 29. That is, as illustrated in FIGS. 21 and 22, the update instruction signal 86 for clearing the number of reversals NR to 0 is output to the RW controller 68 from the counting unit 85. The RW controller 68 clears the number of reversals NR in the storage 50 to 0 in accordance with the update instruction signal 86.

Then, the exposure control continues under control of the driving controller 70 (step ST340). In a case where the number of reversals NR is less than the set number of frames SF (NR<SF, NO in step ST320), the exposure control continues under control of the driving controller 70 (step ST340).

In this case, the state information 61 having content indicating the exposure control state is output to the RW controller 68 from the determination unit 69, and the state information 61 is stored in the storage 50 under control of the RW controller 68 (step ST345). Furthermore, the first target exposure value EV1 of the current frame is output to the RW controller 68 from the driving controller 70 as the second target exposure value EV2, and the second target exposure value EV2 is stored in the storage 50 under control of the RW controller 68 (step ST350).

As in step ST300 in FIG. 27, the difference ΔEVX is output to the RW controller 68 from the determination unit 69, and the difference ΔEVX is stored in the storage 50 under control of the RW controller 68 (step ST355). Then, the processing transitions to the subsequent frame.

In the second embodiment, in a case where the absolute value |ΔEV| of the difference is less than or equal to the first threshold value TH1 and greater than the second threshold value TH2 and where a state where the sign of the difference ΔEV is reversed continues for the set number of frames SF, the driving controller 70 finishes the exposure control.

Setting the threshold value to the relatively small second threshold value TH2 causes the hunting as illustrated in FIG. 24 to be more likely to occur than that in a case where the threshold value is set to the first threshold value TH1. Thus, in the second embodiment, in a case where the state where the sign of the difference ΔEV is reversed continues for the set number of frames SF, it is determined that the hunting has occurred, and the exposure control is forced to be finished. Accordingly, a concern that an unnecessary exposure control continues ceaselessly can be reduced.

The determination unit 69 outputs the difference ΔEVX of the previous frame to the RW controller 68. The RW controller 68 stores the difference ΔEVX in the storage 50. Thus, whether or not the signs of the difference ΔEV of the current frame and the difference ΔEVX of the previous frame are reversed and whether or not the hunting has occurred can be reliably perceived.

The determination unit 69 stores the difference ΔEVX in the storage 50 only in a case where the state of the current frame indicated by the state information 61 is the exposure control state. Thus, only the difference ΔEVX related to whether or not the hunting has occurred can be stored in the storage 50, and unnecessary information is not stored in the storage 50.

### Third Embodiment

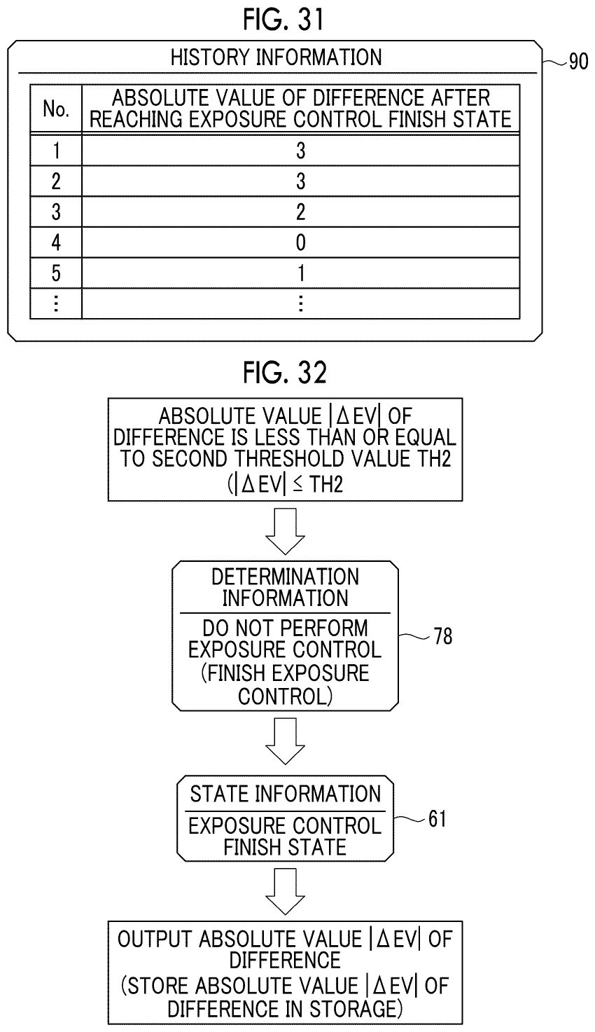

As illustrated in FIG. 30 as an example, in a third embodiment, history information 90 is stored in the storage 50. As illustrated in FIG. 31 as an example, the history information 90 is a set of histories of the absolute value |ΔEV| of the difference after reaching the exposure control finish state. The determination unit 69 outputs the absolute value |ΔEV| of the difference to the RW controller 68. The RW controller 68 registers the absolute value |ΔEV| of the difference in the history information 90.

The RW controller 68 outputs a maximum value |ΔEV|max in the histories of the absolute value |ΔEV| of the difference registered in the history information 90 to the determination unit 69 as the second threshold value TH2. The determination unit 69 determines whether or not to perform the exposure control by comparing the magnitude of the absolute value |ΔEV| of the difference calculated from the first target exposure value EV1 and from the second target exposure value EV2 with the magnitude of the second threshold value TH2 based on the maximum value |ΔEV|max. Hereinafter, the second threshold value TH2 based on the maximum value |ΔEV|max will be referred to as TH2max in order to distinguish the second threshold value TH2 from the default second threshold value TH2.

As illustrated in FIG. 32 as an example, in a case where it is determined not to perform the exposure control because the absolute value |ΔEV| of the difference becomes less than or equal to the second threshold value TH2 and where the state of the current frame reaches the exposure control finish state, the determination unit 69 outputs the absolute value |ΔEV| of the difference to the RW controller 68. The RW controller 68 stores the absolute value |ΔEV| of the difference in the storage 50 by registering the absolute value |ΔEV| of the difference in the history information 90.

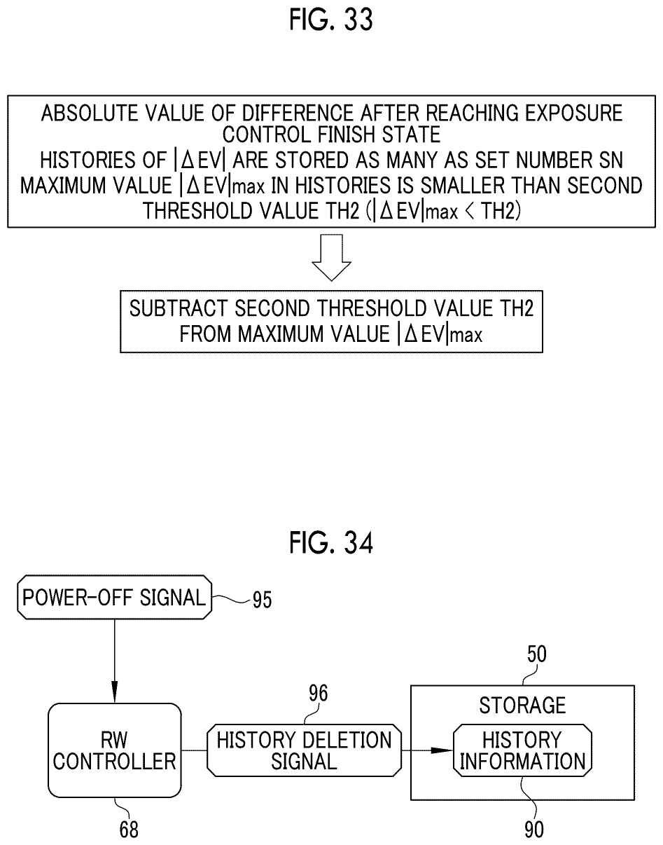

In addition, as illustrated in FIG. 33 as an example, in a case where the histories of the absolute value |ΔEV| of the difference after reaching the exposure control finish state are stored in the storage 50 as many as a set number SN and where the maximum value |ΔEV|max in the histories of the absolute value |ΔEV| of the difference after reaching the exposure control finish state is smaller than the second threshold value TH2 (|ΔEV|max<TH2), the RW controller 68 subtracts the second threshold value TH2 from the maximum value |ΔEV|max and sets the second threshold value TH2max. The RW controller 68 outputs the second threshold value TH2max to the determination unit 69. The set number SN is, for example, 10 to 15.

In a case where a power button of the operating unit 21 is operated by the user to provide an instruction to power the imaging apparatus 10 off, a power-off signal 95 is received by the instruction receiving unit 37. As illustrated in FIG. 34 as an example, the power-off signal 95 is input into the RW controller 68 from the instruction receiving unit 37. The RW controller 68 that has received the power-off signal 95 outputs a history deletion signal 96 for deleting the histories of the absolute value |ΔEV| of the difference after reaching the exposure control finish state that have been registered in the history information 90 so far. The instruction to power the imaging apparatus 10 off is an example of an “operation instruction set in advance” according to the disclosed technology. The RW controller 68 newly starts storing the histories of the absolute value |ΔEV| of the difference after reaching the exposure control finish state in a case where the imaging apparatus 10 is powered on.

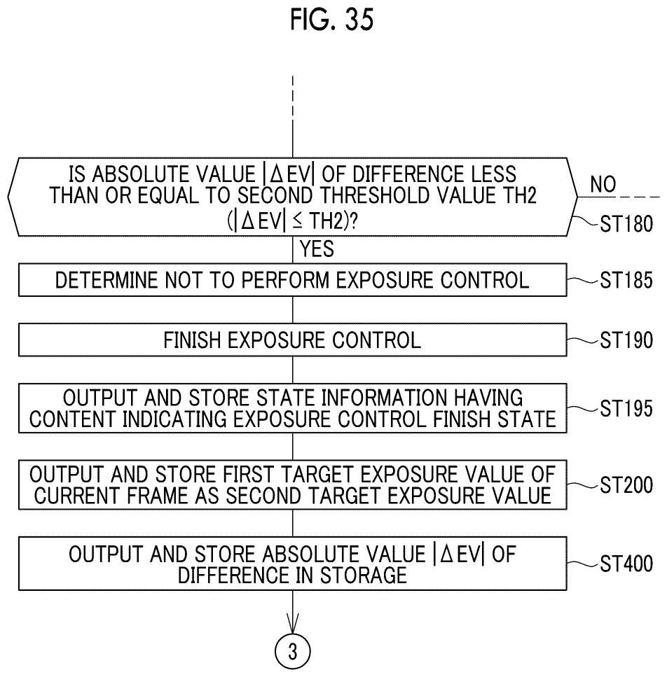

An action of the third embodiment will be described with reference to the flowcharts illustrated in FIGS. 35 to 37 as an example. Description of the same processing as the first embodiment will be omitted as much as possible, and processing specific to the third embodiment will be mainly described.

First, as illustrated in FIG. 35, in a case where the absolute value |ΔEV| of the difference is less than or equal to the second threshold value TH2 (YES in step ST180), the determination unit 69 determines not to perform the exposure control (step ST185), and the exposure control by the driving controller 70 is finished (step ST190), the absolute value |ΔEV| of the difference is output to the RW controller 68 from the determination unit 69 as illustrated in FIG. 32, and the absolute value |ΔEV| of the difference is stored in the storage 50 under control of the RW controller 68 (step ST400).

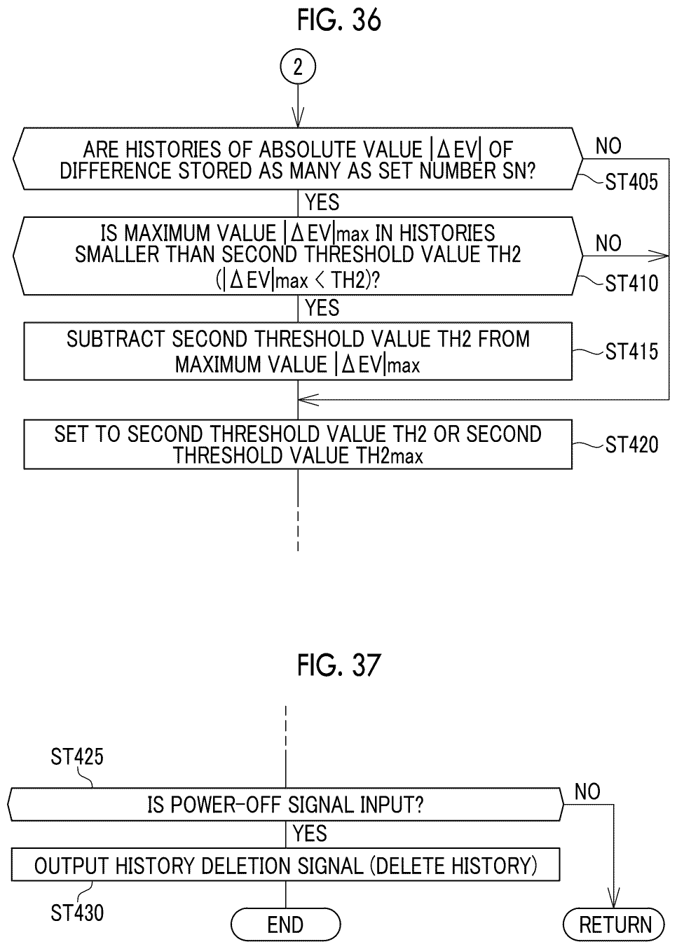

As illustrated in FIG. 36, in a case where the state of the previous frame indicated by the state information 61 is the exposure control state (NO in step ST115), the RW controller 68 performs a search to determine whether or not the histories of the absolute value |ΔEV| of the difference after reaching the exposure control finish state are stored in the storage 50 as many as the set number SN (step ST405).

In a case where the histories of the absolute value |ΔEV| of the difference are stored in the storage 50 as many as the set number SN (YES in step ST405), the RW controller 68 compares a magnitude of the maximum value |ΔEV|max in the histories with the magnitude of the second threshold value TH2 (step ST410).

In a case where the maximum value |ΔEV|max is smaller than the second threshold value TH2 (|ΔEV|max<TH2, YES in step ST410), the RW controller 68 subtracts the second threshold value TH2 from the maximum value |ΔEV|max and sets the second threshold value TH2max as illustrated in FIG. 33 (step ST415). Then, the setting unit 67 sets the threshold value to the second threshold value TH2max (step ST420).

Meanwhile, in a case where the histories of the absolute value |ΔEV| of the difference are not stored in the storage 50 as many as the set number SN (NO in step ST405), or in a case where the maximum value |ΔEV|max is equal to the second threshold value TH2 (|ΔEV|max=TH2, NO in step ST410), the setting unit 67 sets the threshold value to the second threshold value TH2 without subtracting the second threshold value TH2 from the maximum value |ΔEV|max (step ST420).

In addition, in a case where the power button of the operating unit 21 is operated by the user to provide the instruction to power the imaging apparatus 10 off as illustrated in FIG. 37 and where the power-off signal 95 is input into the RW controller 68 as illustrated in FIG. 34 (YES in step ST425), the history deletion signal 96 is output from the RW controller 68. Accordingly, the histories of the absolute value |ΔEV| of the difference after reaching the exposure control finish state that have been registered in the history information 90 so far are deleted (step ST430).

In the third embodiment, the RW controller 68 stores the histories of the absolute value |Δ EV| of the difference after reaching the exposure control finish state in the storage 50. In a case where the maximum value |ΔEV|max in the histories is smaller than the second threshold value TH2, the second threshold value TH2 is subtracted from the maximum value |ΔEV|max. Thus, the second threshold value TH2 can be set to a value suitable for the imaging scene. In addition, the concern that the exposure control finish state is reached while a significant increase in the difference ΔEV between the first target exposure value EV1 and the second target exposure value EV2 is maintained and that a state where an image having appropriate brightness cannot be provided is reached can be further reduced.

In a case where the histories of the absolute value |ΔEV| of the difference after reaching the exposure control finish state are stored in the storage 50 as many as the set number SN, the RW controller 68 performs processing of subtracting the second threshold value TH2 from the maximum value |ΔEV|max. Thus, validity of the processing of subtracting the second threshold value TH2 from the maximum value |ΔEV|max can be secured.

In a case where the instruction to power the imaging apparatus 10 off is received, the RW controller 68 does not hand over the histories of the absolute value |ΔEV| of the difference after reaching the exposure control finish state stored in the storage 50. More specifically, the histories of the absolute value |ΔEV| of the difference after reaching the exposure control finish state are deleted from the storage 50. Powering the imaging apparatus 10 off indicates that capturing of the image in the imaging scene is finished. Thus, in a case where the imaging apparatus 10 is powered off, the histories of the absolute value |ΔEV| of the difference are not handed over and are deleted in order to newly store the histories of the absolute value |ΔEV| of the difference in a subsequent imaging scene. Accordingly, the second threshold value TH2 can be always set to a value suitable for the imaging scene.

The operation instruction set in advance is not limited to the illustrated instruction to power the imaging apparatus 10 off. An instruction to perform a zoom operation, an instruction to switch from the video capturing mode to the image playback mode, or the like may be applied. In addition, as a method of not handing over the histories, not only deleting the histories but also, for example, a method of not handling data stored in the storage 50 as the histories are considered.

The processing of subtracting the second threshold value TH2 may be performed not only once but also any number of times. In a case where the default second threshold value TH2 is, for example, 5, the second threshold value TH2 may be subtracted over a plurality of steps such as 5, 4, 3, . . . .

The second frame is not limited to the previous frame earlier than the current frame by one frame. A predetermined number of frames grouped from the current frame may be used as the second frame. In this case, the second target exposure value EV2 is a representative value such as an average value of the second target exposure values EV2 of the grouped frames.

### Fourth Embodiment

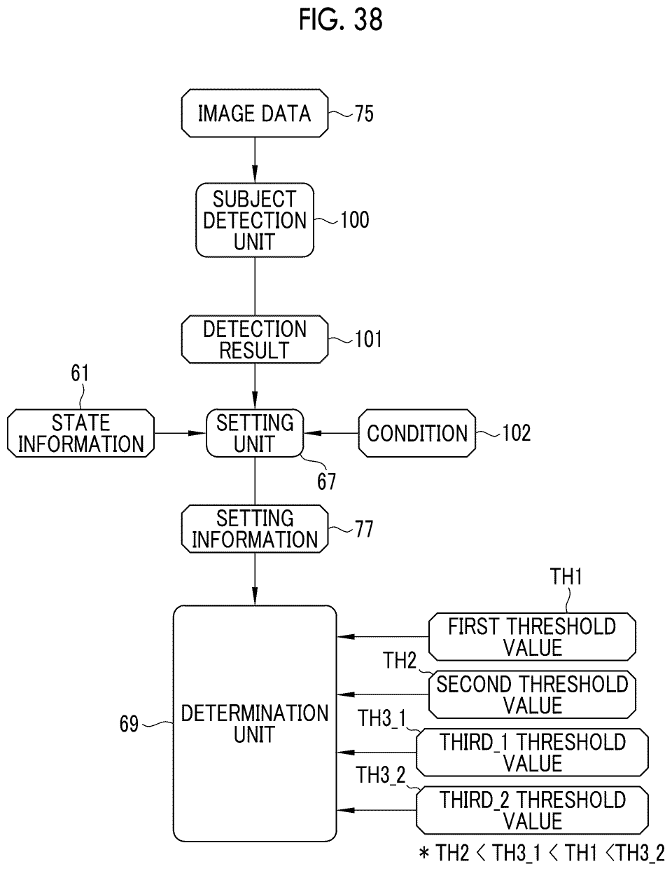

As illustrated in FIG. 38 as an example, in a fourth embodiment, the CPU 51 of the controller 20 functions as a subject detection unit 100 in addition to each of the processing units 65 to 70 (in FIG. 38, only the setting unit 67 and the determination unit 69 are illustrated) of the first embodiment. The image data 75 is input into the subject detection unit 100. The subject detection unit 100 detects a person as a subject captured in the image represented by the image data 75. The subject detection unit 100 outputs a detection result 101 of the person to the setting unit 67.

The state information 61 from the RW controller 68 and the detection result 101 from the subject detection unit 100 are input into the setting unit 67. In addition, a condition 102 based on the detection result 101 is input into the setting unit 67. The condition 102 is stored in the storage 50 and is read out from the storage 50 and output to the setting unit 67 under control of the RW controller 68.

In the fourth embodiment, a third_1 threshold value TH3_1 and a third_2 threshold value TH3_2 can be set as the threshold value, in addition to the first threshold value TH1 and the second threshold value TH2. Both of the third_1 threshold value TH3_1 and the third_2 threshold value TH3_2 are greater than the second threshold value TH2 (TH2<TH3_1 and TH3_2). In addition, the third_1 threshold value TH3_1 is smaller than the first threshold value TH1 (TH3_1<TH1). The third_2 threshold value TH3_2 is greater than the first threshold value TH1 (TH1<TH3_2). For example, the first threshold value TH1 is 20, the second threshold value TH2 is 5, the third_1 threshold value TH3_1 is 18, and the third_2 threshold value TH3_2 is 22.

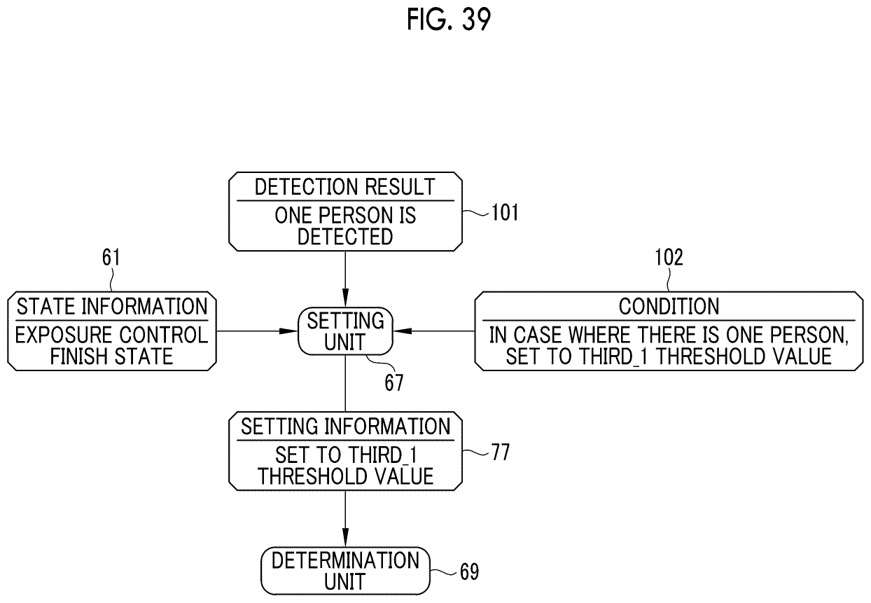

As illustrated in FIG. 39 as an example, in a case where the state of the previous frame indicated by the state information 61 is the exposure control finish state and where content of the detection result 101 indicates that one person is detected, the setting unit 67 sets the threshold value to the third_1 threshold value TH3_1 in accordance with the condition 102 indicating that the third_1 threshold value TH3_1 is set in a case where there is one person. The setting unit 67 outputs the setting information 77 indicating that the threshold value is set to the third_1 threshold value TH3_1 to the determination unit 69. In this case, the determination unit 69 determines whether or not to perform the exposure control by comparing the magnitude of the absolute value |ΔEV| of the difference with a magnitude of the third_1 threshold value TH3_1.

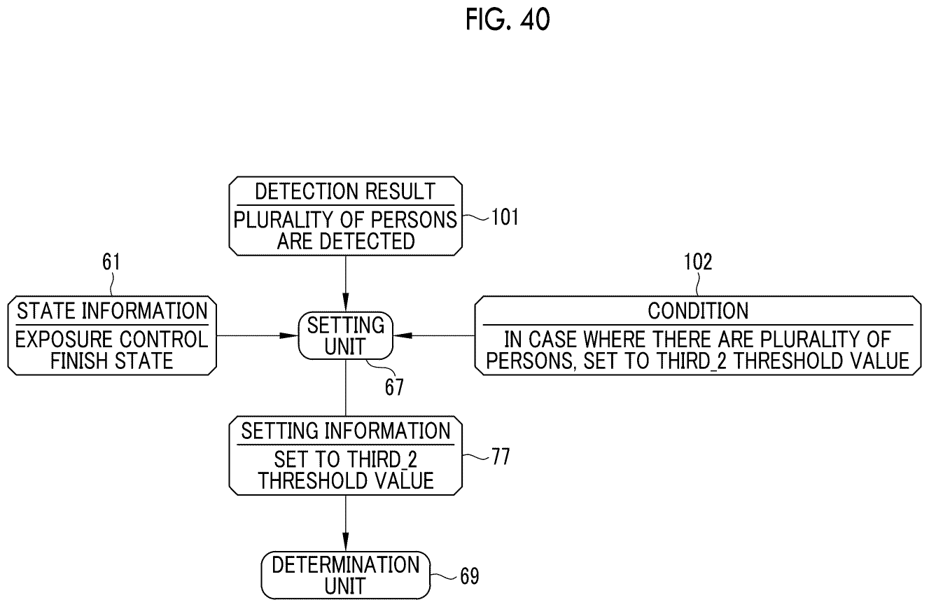

As illustrated in FIG. 40 as an example, in a case where the state of the previous frame indicated by the state information 61 is the exposure control finish state and where the content of the detection result 101 indicates that a plurality of persons are detected, the setting unit 67 sets the threshold value to the third_2 threshold value TH3_2 in accordance with the condition 102 indicating that the third_2 threshold value TH3_2 is set in a case where there are a plurality of persons. The setting unit 67 outputs the setting information 77 indicating that the threshold value is set to the third_2 threshold value TH3_2 to the determination unit 69. In this case, the determination unit 69 determines whether or not to perform the exposure control by comparing the magnitude of the absolute value |ΔEV| of the difference with a magnitude of the third_2 threshold value TH3_2. In a case where the detection result 101 does not satisfy the condition 102 such that there is no person captured in the image represented by the image data 75, the setting unit 67 sets the threshold value to the first threshold value TH1.

In the fourth embodiment, the setting unit 67 sets the third threshold value different from the first threshold value TH1, that is, the third_1 threshold value TH3_1 or the third_2 threshold value TH3_2, in accordance with the condition 102. Thus, a threshold value corresponding to the condition 102 can be set.

The setting unit 67 sets the third_1 threshold value TH3_1 smaller than the first threshold value TH1. Thus, the exposure control can quickly follow a change in the imaging scene compared with a case where the first threshold value TH1 is set.

As illustrated in FIG. 39, in a case where there is one person captured in the image represented by the image data 75, the threshold value is set to the third_1 threshold value TH3_1 smaller than the first threshold value TH1 in order to cause the exposure control to quickly follow a change in the imaging scene corresponding to a motion of the person. Meanwhile, as illustrated in FIG. 40, in a case where there are a plurality of persons captured in the image represented by the image data 75, the threshold value is set to the third_2 threshold value TH3_2 greater than the first threshold value TH1 so that an oversensitive response to a change in the imaging scene corresponding to motions of the plurality of persons is not made. In a case where the threshold value is set in accordance with the condition 102 based on the detection result 101 of the subject detection unit 100, a more appropriate exposure control can be performed.

The fourth embodiment may be combined with the second embodiment and/or the third embodiment.

The imaging apparatus according to the disclosed technology may be a compact digital camera, a smartphone, or a tablet terminal.

In each of the embodiments, for example, various processors illustrated below can be used as a hardware structure of a processing unit that executes various types of processing, such as the image processing unit 32, the display controller 35, the instruction receiving unit 37, the photometry unit 65, the calculation unit 66, the setting unit 67, the RW controller 68, the determination unit 69, the driving controller 70, the counting unit 85, and the subject detection unit 100. For example, the various processors include, in addition to the CPU 51 that is a general-purpose processor functioning as various processing units by executing software (operation program 60), a programmable logic device (PLD) such as a field programmable gate array (FPGA) that is a processor having a circuit configuration changeable after manufacture, and/or a dedicated electric circuit such as an application specific integrated circuit (ASIC) that is a processor having a circuit configuration dedicatedly designed to execute specific processing.

One processing unit may be composed of one of the various processors or may be composed of a combination of two or more processors of the same type or different types (for example, a combination of a plurality of FPGAs and/or a combination of a CPU and an FPGA). In addition, a plurality of processing units may be composed of one processor.

Examples of the plurality of processing units composed of one processor include, first, as represented by a computer such as a client and a server, a form in which one processor is composed of a combination of one or more CPUs and software, and the processor functions as the plurality of processing units. Second, as represented by a system on chip (SoC) or the like, a form of using a processor that implements functions of the entire system including the plurality of processing units in one integrated circuit (IC) chip is included. Various processing units are configured using one or more of the various processors as the hardware structure.

Furthermore, more specifically, an electric circuit (circuitry) in which circuit elements such as semiconductor elements are combined can be used as the hardware structure of the various processors.

From the above description, a technology according to the following appendixes can be perceived.

### Appendix 1

An exposure control device that performs an exposure control of causing an exposure value in an imaging apparatus to follow a target exposure value, the exposure control device comprising a processor, in which the processor is configured to start the exposure control in a case where an absolute value of a difference between a first target exposure value of a first frame captured by the imaging apparatus and a second target exposure value of a second frame captured earlier than the first frame is increased above a first threshold value, acquire a second threshold value smaller than the first threshold value in accordance with the start of the exposure control, and in a case where a magnitude relationship between the absolute value of the difference and the second threshold value satisfies a condition set in advance, set a threshold value to be compared with the absolute value of the difference to a third threshold value greater than the second threshold value and finish the exposure control.

### Appendix 2

The exposure control device according to Appendix 1, in which the processor is configured to set the third threshold value to the same value as the first threshold value.

### Appendix 3

The exposure control device according to Appendix 1 or 2, in which the processor is configured to set the third threshold value to a value different from the first threshold value in accordance with a condition.

### Appendix 4

The exposure control device according to Appendix 3, in which the processor is configured to set the third threshold value to a value smaller than the first threshold value in accordance with the condition.

### Appendix 5

The exposure control device according to Appendix 3 or 4, in which the condition is a condition based on a detection result of a subject.

### Appendix 6

The exposure control device according to any one of Appendixes 1 to 5, in which the processor is configured to, in a case where the absolute value of the difference becomes less than or equal to the second threshold value, set the threshold value to be compared with the absolute value of the difference to the third threshold value greater than the second threshold value and finish the exposure control.

### Appendix 7

The exposure control device according to any one of Appendixes 1 to 6, in which the processor is configured to store whether the absolute value of the difference is greater than the first threshold value, the second threshold value, or the third threshold value and an exposure control state in which the exposure control is performed is reached, or the absolute value of the difference becomes less than or equal to the first threshold value, the second threshold value, or the third threshold value and an exposure control finish state in which the exposure control is finished is reached, in a storage unit for each frame.

### Appendix 8

The exposure control device according to Appendix 7, in which the processor is configured to set the threshold value to be compared with the absolute value of the difference to the first threshold value or to the third threshold value in a case where the second frame is in the exposure control finish state, and set the threshold value to be compared with the absolute value of the difference to the second threshold value in a case where the second frame is in the exposure control state.

### Appendix 9

The exposure control device according to Appendix 7 or 8, in which the processor is configured to store the second target exposure value in the storage unit for each frame.

### Appendix 10

The exposure control device according to any one of Appendixes 1 to 9, in which the processor is configured to, in a case where the absolute value of the difference is less than or equal to the first threshold value or the third threshold value and greater than the second threshold value and where a state where a sign of the difference is reversed continues for the number of frames set in advance, set the threshold value to be compared with the absolute value of the difference to the third threshold value greater than the second threshold value and finish the exposure control.

### Appendix 11

The exposure control device according to Appendix 10, in which the processor is configured to store the difference in a storage unit.

### Appendix 12

The exposure control device according to Appendix 11, in which the processor is configured to store whether the absolute value of the difference is greater than the first threshold value, the second threshold value, or the third threshold value and an exposure control state in which the exposure control is performed is reached, or the absolute value of the difference becomes less than or equal to the first threshold value, the second threshold value, or the third threshold value and an exposure control finish state in which the exposure control is finished is reached, in the storage unit for each frame, and store the difference in the storage unit only in a case where the first frame is in the exposure control state.

### Appendix 13

The exposure control device according to any one of Appendixes 7 to 12, in which the processor is configured to store histories of the absolute value of the difference after reaching the exposure control finish state in the storage unit, and subtract the second threshold value from a maximum value in the histories in a case where the maximum value is smaller than the second threshold value.

### Appendix 14

The exposure control device according to Appendix 13, in which the processor is configured to, in a case where the histories are stored in the storage unit as many as a number set in advance, perform processing of subtracting the second threshold value from the maximum value.

### Appendix 15

The exposure control device according to Appendix 13 or 14, in which the processor is configured to not hand over the histories stored in the storage unit in a case where an operation instruction set in advance is received.

### Appendix 16

The exposure control device according to Appendix 15, in which the processor is configured to delete the histories from the storage unit in a case where the operation instruction set in advance is received.

### Appendix 17

An imaging apparatus comprising the exposure control device according to any one of Appendixes 1 to 16, and an imaging element.

In the disclosed technology, the above various embodiments and/or various modification examples can be appropriately combined. In addition, not only each of the embodiments but also various configurations may be employed without departing from the gist of the disclosed technology. Furthermore, the disclosed technology also applies to, in addition to the program, a storage medium that stores the program in a non-transitory manner.

The above described contents and illustrated contents are detailed descriptions for parts according to the disclosed technology and are merely an example of the disclosed technology. For example, description related to the above configurations, functions, actions, and effects is description related to an example of configurations, functions, actions, and effects of the parts according to the disclosed technology. Thus, of course, unnecessary parts may be removed, new elements may be added, or parts may be replaced in the above described contents and the illustrated contents without departing from the gist of the disclosed technology. In addition, particularly, description related to common technical knowledge or the like that does not need to be described in terms of embodying the disclosed technology is omitted in the above described contents and the illustrated contents in order to avoid complication and to facilitate understanding of the parts according to the disclosed technology.

In the present specification, “A and/or B” is synonymous with “at least one of A or B”. That is, “A and/or B” may mean only A, only B, or a combination of A and B. In addition, in the present specification, the same approach as “A and/or B” is applied to a case where three or more matters are represented by connecting the matters with “and/or”.

All documents, patent applications, and technical standards described in the present specification are incorporated in the present specification by reference to the same extent as in a case where each of the documents, the patent applications, and the technical standards are specifically and individually indicated to be incorporated by reference.

What is claimed is:

1. An exposure control device that performs an exposure control of causing an exposure value in an imaging apparatus to follow a target exposure value, the exposure control device comprising:
a processor,
wherein the processor is configured to:
start the exposure control in a case where an absolute value of a difference between a first target exposure value of a first frame captured by the imaging apparatus and a second target exposure value of a second frame captured earlier than the first frame is increased above a first threshold value;
acquire a second threshold value smaller than the first threshold value in accordance with the start of the exposure control; and
in a case where a magnitude relationship between the absolute value of the difference and the second threshold value satisfies a condition set in advance, set a threshold value to be compared with the absolute value of the difference to a third threshold value greater than the second threshold value and finish the exposure control.

2. The exposure control device according to claim 1,
wherein the processor is configured to set the third threshold value to the same value as the first threshold value.

3. The exposure control device according to claim 1,
wherein the processor is configured to set the third threshold value to a value different from the first threshold value in accordance with a condition.

4. The exposure control device according to claim 3,
wherein the processor is configured to set the third threshold value to a value smaller than the first threshold value in accordance with the condition.

5. The exposure control device according to claim 3,
wherein the condition is a condition based on a detection result of a subject.

6. The exposure control device according to claim 1,
wherein the processor is configured to, in a case where the absolute value of the difference becomes less than or equal to the second threshold value, set the threshold value to be compared with the absolute value of the difference to the third threshold value greater than the second threshold value and finish the exposure control.

7. The exposure control device according to claim 1,
wherein the processor is configured to store whether the absolute value of the difference is greater than the first threshold value, the second threshold value, or the third threshold value and an exposure control state in which the exposure control is performed is reached, or the absolute value of the difference becomes less than or equal to the first threshold value, the second threshold value, or the third threshold value and an exposure control finish state in which the exposure control is finished is reached, in a storage unit for each frame.

8. The exposure control device according to claim 7,
wherein the processor is configured to:
set the threshold value to be compared with the absolute value of the difference to the first threshold value or to the third threshold value in a case where the second frame is in the exposure control finish state; and
set the threshold value to be compared with the absolute value of the difference to the second threshold value in a case where the second frame is in the exposure control state.

9. The exposure control device according to claim 7,
wherein the processor is configured to store the second target exposure value in the storage unit for each frame.

10. The exposure control device according to claim 1,
wherein the processor is configured to, in a case where the absolute value of the difference is less than or equal to the first threshold value or the third threshold value and greater than the second threshold value and where a state where a sign of the difference is reversed continues for the number of frames set in advance, set the threshold value to be compared with the absolute value of the difference to the third threshold value greater than the second threshold value and finish the exposure control.

11. The exposure control device according to claim 10,
wherein the processor is configured to store the difference in a storage unit.

12. The exposure control device according to claim 11,
wherein the processor is configured to:
store whether the absolute value of the difference is greater than the first threshold value, the second threshold value, or the third threshold value and an exposure control state in which the exposure control is performed is reached, or the absolute value of the difference becomes less than or equal to the first threshold value, the second threshold value, or the third threshold value and an exposure control finish state in which the exposure control is finished is reached, in the storage unit for each frame; and
store the difference in the storage unit only in a case where the first frame is in the exposure control state.

13. The exposure control device according to claim 7,
wherein the processor is configured to:
store histories of the absolute value of the difference after reaching the exposure control finish state in the storage unit; and
subtract the second threshold value from a maximum value in the histories in a case where the maximum value is smaller than the second threshold value.

14. The exposure control device according to claim 13,
wherein the processor is configured to, in a case where the histories are stored in the storage unit as many as a number set in advance, perform processing of subtracting the second threshold value from the maximum value.

15. The exposure control device according to claim 13,
wherein the processor is configured to not hand over the histories stored in the storage unit in a case where an operation instruction set in advance is received.

16. The exposure control device according to claim 15,
wherein the processor is configured to delete the histories from the storage unit in a case where the operation instruction set in advance is received.

17. An imaging apparatus comprising:
the exposure control device according to claim 1; and
an imaging element.

18. A non-transitory computer-readable storage medium storing an operation method of an exposure control device that performs an exposure control of causing an exposure value in an imaging apparatus to follow a target exposure value, the operation method comprising:
starting the exposure control in a case where an absolute value of a difference between a first target exposure value of a first frame captured by the imaging apparatus and a second target exposure value of a second frame captured earlier than the first frame is increased above a first threshold value;
acquiring a second threshold value smaller than the first threshold value in accordance with the start of the exposure control; and
setting, in a case where a magnitude relationship between the absolute value of the difference and the second threshold value satisfies a condition set in advance, a threshold value to be compared with the absolute value of the difference to a third threshold value greater than the second threshold value and finishing the exposure control.

19. An operation program of an exposure control device that performs an exposure control of causing an exposure value in an imaging apparatus to follow a target exposure value, the operation program causing a computer to execute a process comprising:
starting the exposure control in a case where an absolute value of a difference between a first target exposure value of a first frame captured by the imaging apparatus and a second target exposure value of a second frame captured earlier than the first frame is increased above a first threshold value;
acquiring a second threshold value smaller than the first threshold value in accordance with the start of the exposure control; and
setting, in a case where a magnitude relationship between the absolute value of the difference and the second threshold value satisfies a condition set in advance, a threshold value to be compared with the absolute value of the difference to a third threshold value greater than the second threshold value and finishing the exposure control.
